(19) United States
(12) Patent Application Publication
(10) Pub. No.: US 2019/0260325 A1
(43) Pub. Date: Aug. 22, 2019

(54) ELECTRIC MOTOR DRIVE WITH GALLIUM NITRIDE POWER SWITCHES

(71) Applicants: Jiangbo TIAN, Windsor (CA); Chunyan LAI, Windsor (CA); Junxi CAI, Windsor (CA); Narayan Chandra KAR, Windsor (CA); Debmalya BANERJEE, Windsor (CA); Ze LI, Windsor (CA); Jasmin Jijina SINKULAR, Bloomfield Hills, MI (US); Lakshmi Varaha IYER, Troy, MI (US)

(72) Inventors: Jiangbo TIAN, Windsor (CA); Chunyan LAI, Windsor (CA); Junxi CAI, Windsor (CA); Narayan Chandra KAR, Windsor (CA); Debmalya BANERJEE, Windsor (CA); Ze LI, Windsor (CA); Jasmin Jijina SINKULAR, Bloomfield Hills, MI (US); Lakshmi Varaha IYER, Troy, MI (US)

(21) Appl. No.: 16/280,778

(22) Filed: Feb. 20, 2019

Related U.S. Application Data
(60) Provisional application No. 62/633,455, filed on Feb. 21, 2018.

(51) Int. Cl. H02P 27/06; H02P 23/14

(52) U.S. Cl. CPC H02P 27/06; H02P 23/14

(57) ABSTRACT

A motor drive for providing AC power to an electric motor includes a DC bus and three output terminals for connection to the electric motor. A positive switch selectively connects a positive conductor of the DC bus with each of the output terminals and a negative switch selectively connects a negative conductor of the DC bus with each of the output terminals. Each of the switches are Gallium Nitride (GaN) power switches. A controller commands each of the switches at a high switching speed between 10 kHz and 100 kHz using pulse width modulation to approximate an AC waveform on each of the output terminals. A dead time between activation of corresponding two of the switches conn to be selected to minimize a fifth-order harmonic distortion current.

### CROSS-REFERENCE TO RELATED APPLICATIONS

This utility application claims the benefit of U.S. Provisional Application No. 62/633,455, filed Feb. 21, 2018. The entire disclosure of the provisional application being considered part of the disclosure of this application, and hereby incorporated by reference.

### BACKGROUND

Electric motor drives, also known as variable frequency drives (VFDs) are used in a variety of applications to provide alternating current (AC) electrical power to an electric motor. Electric motor drives are frequently used in electric vehicles for powering traction motors at a range of different speeds. Electric motor drives also have industrial and commercial applications such as for running blowers, conveyors, or other machines at a range of different speeds. Electric motor drives generally rely upon solid state switches to switch a DC source via pulse width modulation (PWM) in order to approximate an alternating current waveform on one or more output terminals providing power to the electric motor. Historically, insulated gate bipolar transistors (IGBTs) or metal-oxide-semiconductor field-effect transistors (MOSFETs) are used as the switches. However, IGBTs and MOSFETs are limited in their operating speed and are not generally able to operate at more than 10 kHz to switch the high electrical currents required for motor drive applications.

### SUMMARY

A motor drive for providing AC power to an electric motor is disclosed. The motor drive includes a DC bus having a DC negative conductor and a DC positive conductor having a DC voltage between the DC the DC negative and the DC positive conductors. A capacitor is connected across the DC bus for stabilizing the DC voltage. The motor drive also includes an output terminal for connection of a motor lead to supply AC power to the electric motor, and one or more Gallium Nitride (GaN) power electronic switches for selectively conducting electrical current between one of the DC positive or the DC negative conductor and the output terminal. The motor drive also includes a controller in communication with each of the power electronic switches for coordinating activation thereof at a high switching speed for approximating an AC waveform on the output terminal.

According to another aspect, a motor drive for providing AC power to an electric motor includes a DC bus having a DC negative conductor and a DC positive conductor having a DC voltage between the DC the DC negative and the DC positive conductors. A capacitor is connected across the DC bus for stabilizing the DC voltage. The motor drive also includes an output terminal for connection of a motor lead to supply AC power to the electric motor, and one or more air cooled Gallium Nitride (GaN) power electronic switches for selectively conducting electrical current between one of the DC positive or the DC negative conductor and the output terminal.

A method for operating a motor drive to provide AC power to an electric motor is also provided. The method includes energizing a DC bus with a DC voltage between a DC negative conductor and a DC positive conductor. The method also includes commanding for one or more Gallium Nitride (GaN) power electronic switches to provide electrical continuity between one of the DC negative conductor or the DC positive conductor and an output terminal. The method also includes switching the one or more power electronic switches at a high switching speed to approximate an AC waveform on the output terminal.

Gallium Nitride (GaN) switches can switch between a frequency of 30 kHz and 500 kHz which is much higher than 10 kHz that can be achieved with an IGBT power module. Hence, the size of capacitors, filtering components and heatsinks may be significantly reduced. Moreover, switching losses are reduced in comparison to the IGBT switches at the same switching frequency. Due to the higher switching frequency: a) control accuracy and bandwidth are also improved; and b) if necessary, a filter with minimum size can be connected between the motor drive and the electric motor to provide sinusoidal voltage to the motor. This feature will further enhance the motor efficiency and thermal performance of the motor drive and the electric motor.

Moreover, the size, weight and the ability to connect GaN switches in parallel enables a three-phase motor drive with a current rating more than 500 A/phase at 600 VDC. Also, as a result of weight and size of the switches, multi-phase (more than three phases) electric motor drive system can be realized at the same size and cost of a three-phase IGBT or MOSFET based motor drive. An integrated motor drive can be achieved on the same printed circuit board consisting of controller, capacitor, gate driver, current sensor, filter, inductor, etc. Overall, the aforementioned benefits allows for the construction of a compact electric motor drive with superior performance, reduced weight and cost.

### DESCRIPTION OF THE DRAWINGS

The detailed description refers to the following drawings, in which like numerals refer to like items, and in which:

FIG. 1 is a block diagram of a system in accordance with the present disclosure;

FIG. 2A is a top layout view of a high voltage (HV) switching circuit board in an embodiment of a motor drive;

FIG. 2B is a bottom layout view of the high voltage (HV) switching circuit board of FIG. 2A;

FIG. 3A is a top layout view of a drive control circuit board in an embodiment of a motor drive;

FIG. 3B is a bottom layout view of the drive control circuit board of FIG. 3A;

FIG. 4 is a schematic diagram of a controller in embodiments of the motor drive;

FIG. 5 is a schematic diagram of a signal conditioner circuit in embodiments of the motor drive;

FIG. 6 is a schematic diagram including analog-to-digital converter interfaces for current and voltage measurement in embodiments of the motor drive;

FIG. 7 is a schematic diagram of a first alternative analog-to-digital converter interface for current measurement;

FIG. 8 is a schematic diagram of a second alternative analog-to-digital converter interface for current measurement;

FIG. 9 is a graph showing an example voltage output of an analog-to-digital converter interface with and without a DC offset;

FIG. 10 is a schematic diagram of a voltage level converter for interfacing an encoder to a motor drive;

FIG. 11 is a schematic diagram of a CAN interface in embodiments of the motor drive;

FIG. 12 is a schematic diagram of a first voltage regulator circuit in embodiments of the motor drive;

FIG. 13 is a schematic diagram of a second voltage regulator circuit in embodiments of the motor drive;

FIG. 14 is a schematic diagram of a third voltage regulator circuit in embodiments of the motor drive;

FIG. 15 is a schematic diagram of a fourth voltage regulator circuit in embodiments of the motor drive;

FIG. 16 is a schematic diagram of a fifth voltage regulator circuit in embodiments of the motor drive;

FIG. 17 is a schematic diagram of a sixth voltage regulator circuit in embodiments of the motor drive;

FIG. 18 is a schematic diagram of a power connections in embodiments of the motor drive;

FIG. 19 is a schematic diagram of a gate driver for a positive DC voltage to a phase output in embodiments of the motor drive;

FIG. 20 is a schematic diagram of an example single-phase switching circuit in embodiments of the motor drive;

FIG. 21 is a timing diagram illustrating operation of single-phase switching in embodiments of the motor drive;

FIG. 22 is a graph of three-phase currents and distorted a-phase voltage supplied by a motor drive;

FIG. 23 is a graph illustrating distorted voltages and dq-axes currents of a stationary reference frame;

FIG. 24 is a graph of current output of one phase of a motor drive with a DC bus voltage of 200 V and a switching frequency of 10 kHz;

FIG. 25 is a graph of current output of one phase of a motor drive with a DC bus voltage of 200 V and a switching frequency of 100 kHz;

FIG. 26 is a graph of current output of three phases of a motor drive with a DC bus voltage of 200 V, a switching frequency of 100 kHz, and a dead time of 3 μs;

FIG. 27 is a graph of current output of three phases of a motor drive with a DC bus voltage of 200 V, a switching frequency of 100 kHz, and a dead time of 300 ns;

FIG. 28 is a graph of current output of three phases of a motor drive with a DC bus voltage of 200 V, a switching frequency of 20 kHz, and a dead time of 3 μs;

FIG. 29 is a graph of current output of three phases of a motor drive with a DC bus voltage of 200 V, a switching frequency of 20 kHz, and a dead time of 300 ns;

FIG. 30 is a graph of temperatures of switching transistors in a motor drive;

FIG. 31A is a flow chart of a method for operating a motor drive; and

FIG. 31B is a continuation of the flow chart of FIG. 31A.

### DETAILED DESCRIPTION

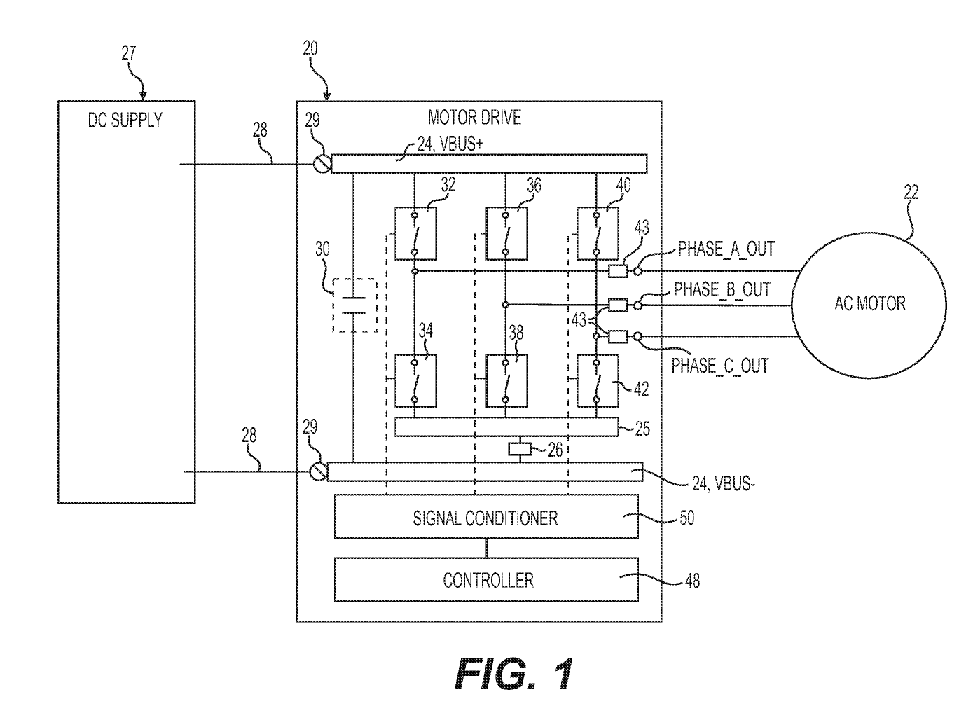

Referring to the Figures, wherein like numerals indicate corresponding parts throughout the several views, a motor drive 20 for providing AC power at a fundamental frequency to an electric motor 22 is disclosed. As best shown in FIG. 1, the motor drive 20 includes a DC bus 24 comprising a DC negative conductor VBUS− and a DC positive conductor VBUS+ having a high DC voltage with respect to the DC negative conductor VBUS−. In some embodiments, the DC bus 24 is energized to about 200 VDC. In other embodiments, the DC bus 24 is energized to about 400 VDC to 500 VDC, although other voltages may be used depending on the supply available and/or the requirements of a given application.

As also shown in FIG. 1, a DC supply 27 energizes the DC bus 24 with the high DC voltage via DC supply leads 28 connected to DC supply terminals 29. The DC supply 27 may be, for example, a battery pack, a DC generator, or a rectifier producing the high DC voltage from an AC source such as a utility line, or from an AC generator. One or more capacitors 30 are connected across the DC bus 24 for stabilizing the high DC voltage.

As also shown in FIG. 1, the motor drive 20 includes a first output terminal PHASE_A_OUT for connection of a first motor lead T1 to supply AC power to the electric motor 22, a second output terminal PHASE_B_OUT for connection of a second motor lead T2 to supply AC power to the electric motor 22, and a third output terminal PHASE_C_OUT for connection of a third motor lead T3 to supply AC power to the electric motor 22. In the example embodiment shown in the figures, a three-phase electric motor 22 is used, however, other numbers of phases may be used, such as a single-phase motor or one having six or more phases.

As also shown in FIG. 1, a negative bus conductor 25 is electrically connected to the DC negative conductor VBUS− of the DC bus 24 via a first shunt resistor 26. The first shunt resistor 26 provides a voltage drop between the DC negative conductor VBUS− and the negative bus conductor 25 that is proportional to the electrical current provided by the DC supply 27. The first shunt resistor 26, therefore, allows the DC current provided by the DC supply 27 to be accurately measured. In some embodiments, the first shunt resistor 26 may have a very low resistance value of 0.005 ohm. However, it should be understood that the first shunt resistor 26 may have a different resistance value that may be chosen to meet specific requirements of a particular application.

As also shown in FIG. 1, the motor drive 20 includes a first positive switch 32 for selectively connecting the DC positive conductor VBUS+ of the DC bus 24 with the first output terminal PHASE_A_OUT, and a first negative switch 34 for selectively connecting the negative bus conductor 25 with the first output terminal PHASE_A_OUT. The motor drive 20 also includes a second positive switch 36 for selectively connecting the DC positive conductor VBUS+ of the DC bus 24 with the second output terminal PHASE_B_OUT, and a second negative switch 38 for selectively connecting the negative bus conductor 25 with the second output terminal PHASE_B_OUT. The motor drive 20 also includes a third positive switch 40 for selectively connecting the DC positive conductor VBUS+ of the DC bus 24 with the third output terminal PHASE_C_OUT, and a third negative switch 42 for selectively connecting the negative bus conductor 25 with the third output terminal PHASE_C_OUT. Each of the positive switches 32, 36, 40 and each of the negative switches 34, 38, 42 are Gallium Nitride (GaN) power switches. In some embodiments, the Gallium Nitride (GaN) power switches may be GS66516B parts from GaN systems.

FIG. 1 also includes a second shunt resistor 43 electrically connected between a set of the switches 32, 34, 36, 38, 40, 42 and a corresponding one of the output terminals PHASE_A_OUT, PHASE_B_OUT, PHASE_C_OUT. Each of the second shunt resistors 43 provides a voltage drop that is proportional to the electrical current provided by the motor drive 20 to the corresponding one of the output terminals PHASE_A_OUT, PHASE_B_OUT, PHASE_C_OUT. The second shunt resistors 43, therefore, allows the AC currents provided by the motor drive 20 to be accurately measured. In some embodiments, the second shunt resistors 43 may have a very low resistance value of 0.01 ohm. However, it should be understood that the second shunt resistors 43 may have a different resistance value that may be chosen to meet specific requirements of a particular application.

As shown in FIG. 1, a signal conditioner 50 is disposed between the controller 48 and the switches 32, 34, 36, 38, 40, 42 for coordinating timing and for preventing an error state output with one of the positive switches 32, 36, 40 and the associated one of the negative switches 34, 38, 42 from being energized simultaneously. The signal conditioner 50 is described in further detail below.

In some embodiments, the motor drive 20 includes a drive control circuit board 44 and a high voltage (HV) switching circuit board 46 are arranged in a stacked configuration, with the drive control circuit board 44 overlying the HV switching circuit board 46. The drive control circuit board 44 includes a controller 48, such as a microcontroller or microprocessor, mounted to a daughter board 49 that is plugged into a socket in the drive control board 44. In one example embodiment, the controller 48 and daughter board 49 are a TMS320F28335 part by Texas Instruments. However, it should be appreciated that the controller 48 may be a different device. The two circuit boards 44, 46 are each described in more detail later in this disclosure.

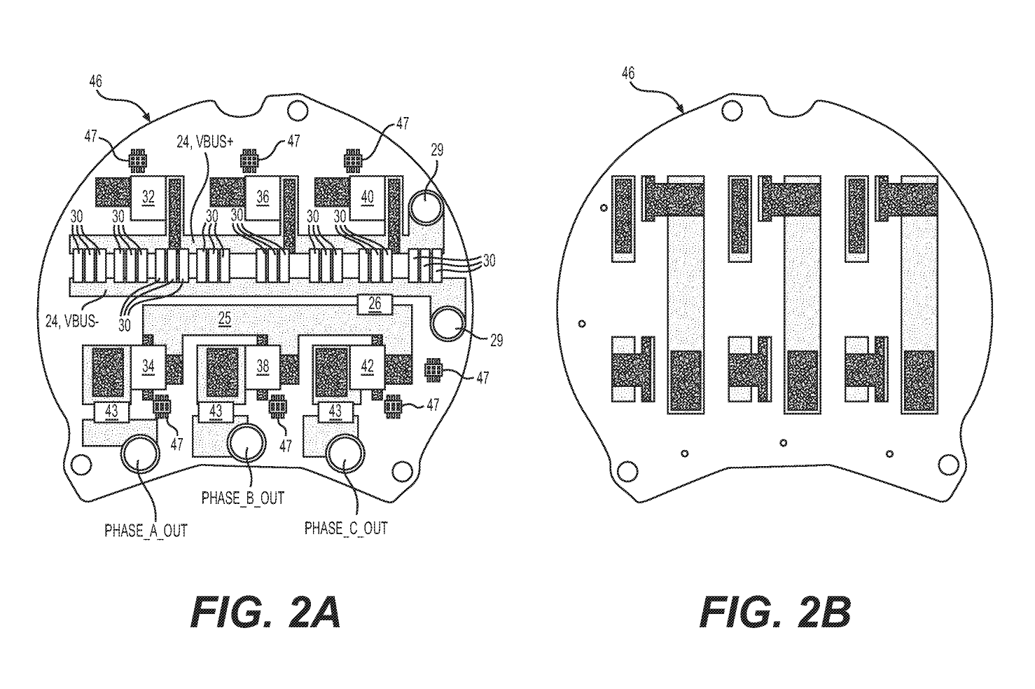

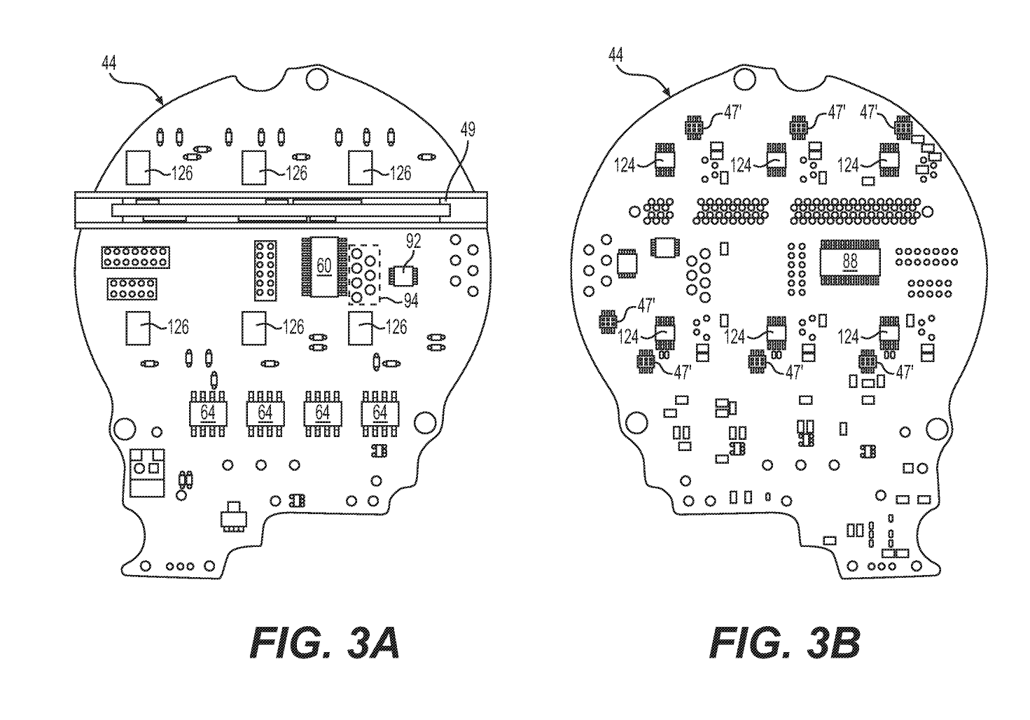

Top and bottom sides of an example embodiment of the HV switching circuit board 46 are shown in FIGS. 2A and 2B, respectively. The HV switching circuit board 46 holds various components of the motor drive 20 and provides electrical connections between those components and to external devices. The HV switching circuit board 46 includes each of the switches 32, 34, 36, 38, 40, 42 and the corresponding DC bus, negative bus conductor 25, shunt resistors 26, 43, the capacitors 30, as well as the DC supply terminals 29, and the output terminals PHASE_A_OUT, PHASE_B_OUT, PHASE_C_OUT. The HV switching circuit board 46 includes several male 6-pin connectors 47 for making electrical contact with corresponding female 6-pin connectors 47′ on the drive control circuit board 44, shown on FIG. 3B for conveying control and/or monitoring signals between the circuit boards 44, 46. The 6-pin connectors 47, 47′ may be removable to facilitate assembly and/or disassembly of the motor drive 20, such as in the example embodiment shown. Alternatively, 6-pin connectors 47, 47′ may be permanently fixed between the circuit boards 44, 46. It should be appreciated that one or more of the 6-pin connectors 47, 47′ may be provided in other physical configurations, such as, for example, wires or ribbon cables. It should also be appreciated that one or more of the 6-pin connectors 47, 47′ may have more than or fewer than six electrical connections or pins. FIG. 2A shows electrically conductive traces as lightly shaded areas on the drive control circuit board 44. FIG. 2A also shows regions with an array of vias for providing electrical conductivity between two or more layers as darker shaded areas. Those via arrays may provide additional current carrying capacity over single-layer traces. It should be appreciated that the configuration shown in FIG. 2A is an example configuration and that the subject motor drive 20 could have a different construction or configuration.

FIG. 2B shows the bottom side of the HV switching circuit board 46 being relatively flat. This configuration allows a heat sink to be placed in thermal communication with the HV switching circuit board 46, and particularly to regions adjacent or near each of the switches 32, 34, 36, 38, 40, 42 for removing heat from the switches 32, 34, 36, 38, 40, 44.

Top and bottom sides of an example embodiment of the drive control circuit board 44 are shown in FIGS. 3A and 3B, respectively. The drive control circuit board 44 includes all of the remaining electrical components of the motor drive 20 which are not located on the HV switching circuit board 46. The drive control circuit board 44 also includes electrical interconnections between the electrical components located thereupon and electrical connections to the HV switching circuit board 46, which may be in the form removable pins and sockets.

As shown in FIG. 3A, the drive control circuit board 44 includes a controller 48 mounted on a daughter board 49 generally transverse to the drive control circuit board 44. The controller 48 is in communication with each of the switches 32, 34, 36, 38, 40, 42 for coordinating activation thereof at a high switching speed using pulse width modulation (PWM) to approximate an AC waveform on each of the output terminals PHASE_A_OUT, PHASE_B_OUT, PHASE_C_OUT. The high switching speed is preferably between 30 kHz and 500 kHz. The controller 48 may include a traditional microprocessor or microcontroller, a digital signal processor, and/or a field programmable gate array. The controller 48 may function to control the electric motor using close-loop field oriented control and/or direct torque control with high switching frequency. The controller 48 may include on-board and/or external computer readable storage memory for storing data and/or program instructions. It should be appreciated that the controller 48 may take other physical forms or configurations. For example, the processor 48 may be mounted directly to one of the circuit boards 44, 46 and/or remotely therefrom with some communications interface allowing the processor 48 to control the operation of the motor drive 20.

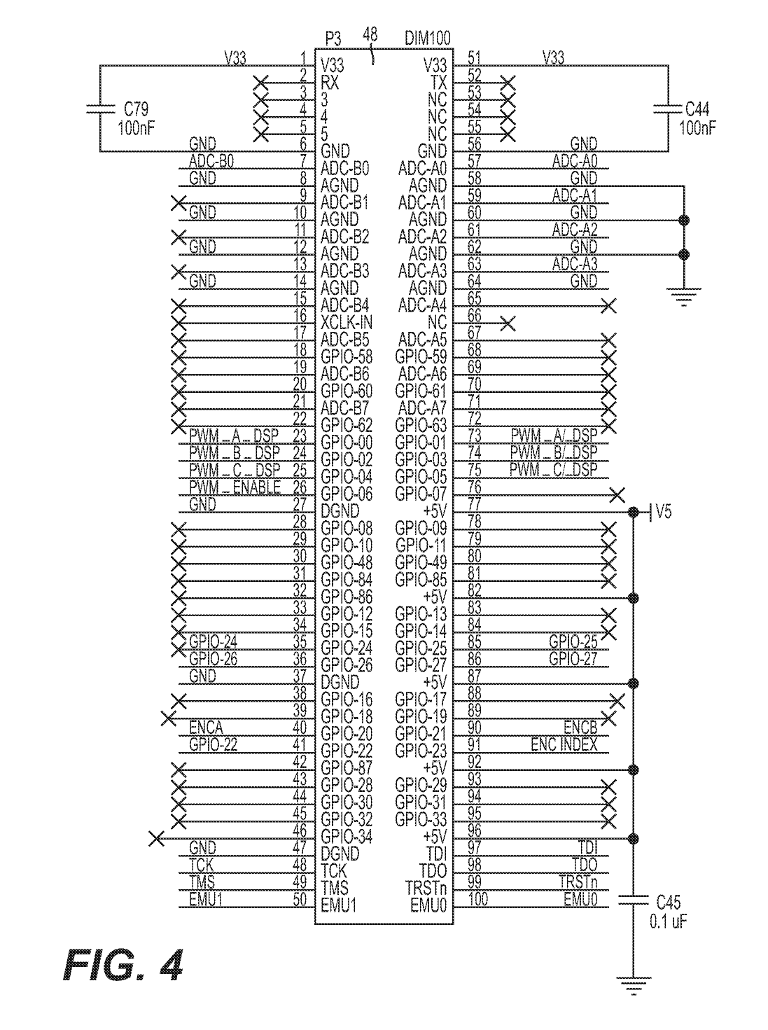

Referring now to FIG. 4, the controller 48 includes several I/O interfaces, which may be configured as inputs or as outputs, with inputs allowing the controller 48 to monitor a digital or analog condition and with outputs allowing the controller 48 to control some aspect of the motor controller 20. Of particular importance are the terminals on the controller 48 labeled PWM_ENABLE, PWM_A_DSP, PWM_A/DSP, PWM_B DSP, PWM_B/DSP, PWM_C_DSP, and PWM_C/DSP, which are used to control each of the switches 32, 34, 36, 38, 40, 42 using pulse width modulation (PWM) as described below.

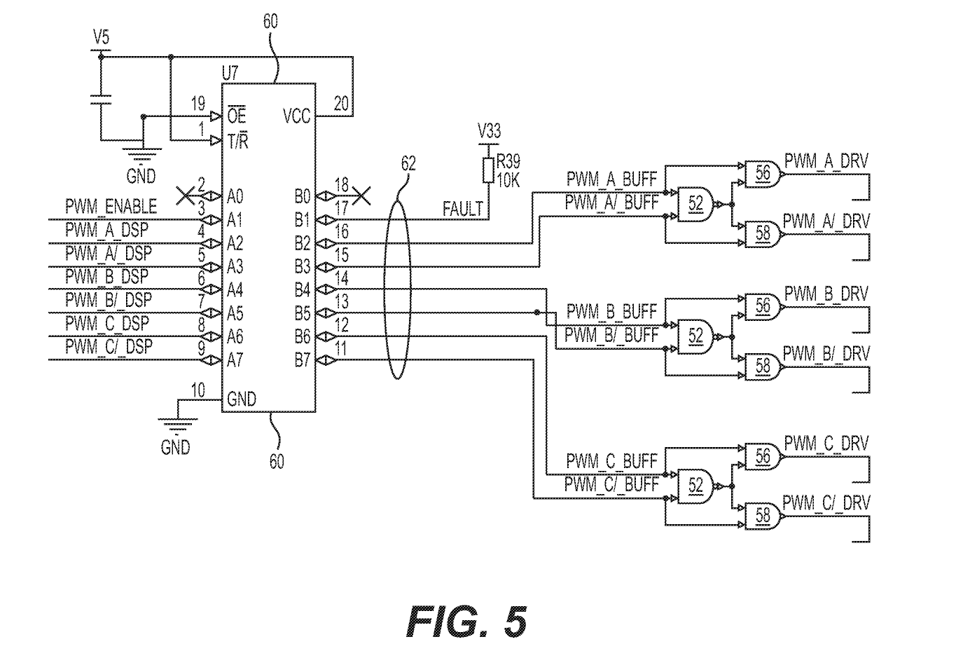

As shown in FIGS. 4-5, a first positive control output PWM_A_DSP goes from the controller 48 to the signal conditioner 50 for enabling the first positive switch 32 to conduct electrical current between the DC positive conductor VBUS+ and the first output terminal PHASE_A_OUT. A first negative control output PWM_A/DSP also goes from the controller 48 to the signal conditioner 50 for enabling the first negative switch 34 to conduct electrical current between the DC negative conductor VBUS− and the first output terminal PHASE_A_OUT. Similarly, second positive and negative control outputs, PWM_B DSP, PWM_B/DSP each go from the controller 48 to the signal conditioner 50 for enabling second positive and negative switches 36, 38 to conduct electrical current from the positive and negative DC bus VBUS+, VBUS−, respectively, to the second output terminal PHASE_B_OUT. Also similarly, third positive and negative control outputs, PWM_C_DSP, PWM_C/DSP each go from the controller 48 to the signal conditioner 50 for enabling third positive and negative switches 40, 42 to conduct electrical current from the positive and negative DC bus VBUS+, VBUS− respectively, to the third output terminal PHASE_C_OUT.

As shown in FIGS. 4-5 the controller 48 may provide an enable control output PWM_ENABLE to a bus transceiver 60 of signal conditioner 50 for producing buffered outputs 62 corresponding to the positive and negative control outputs for enabling electrical current flow to the output terminals PHASE_A_OUT, PHASE_B_OUT, PHASE_C_OUT. Specifically, the buffered outputs 62 include a first positive buffered output PWM_A_BUFF corresponding to the first positive control output PWM_A_DSP and a first negative buffered output PWM_A/_BUFF corresponding to the first negative control output PWM_A/_DSP. The buffered outputs 62 also include a second positive buffered output PWM_B_BUFF corresponding to the second positive control output PWM_B DSP and a second negative buffered output PWM_B/_BUFF corresponding to the second negative control output PWM_B/_DSP. The buffered outputs 62 also include a third positive buffered output PWM_C_BUFF corresponding to the third positive control output PWM_C_DSP and a third negative buffered output PWM_C/_BUFF corresponding to the third negative control output PWM_C/_DSP. The buffered outputs 62 may be synchronized by bus transceiver 60 to correspond with the enable control output PWM_ENABLE. The bus transceiver 60 may be, for example, a DM74LS245WM device from Fairchild semiconductor. However, it should be appreciated that the bus transceiver may take other forms including one or more different components.

As shown in FIG. 5, the signal conditioner 50 includes a NAND gate 52 associated with each of the output terminals PHASE_A_OUT, PHASE_B_OUT, PHASE_C_OUT. Each of the NAND gates 52 taking two inputs including one of the positive buffered outputs PWM_A_BUFF, PWM_B_BUFF, PWMC_BUFF and a corresponding one of the negative control outputs PWM_A/BUFF, PWM_B/BUFF, PWM_C/_BUFF and producing an output OK signal 54 unless both of the inputs are energized. In other words, the OK signal 54 is set to an off state if and only if positive control outputs PWM_A_BUFF, PWM_B_BUFF, PWM_C_BUFF and the corresponding one of the negative control outputs PWM_A/_BUFF, PWM_B/_BUFF, PWM_C/_BUFF are both energized at the same time. This would correspond to a fault condition that could otherwise cause a short circuit across the DC bus 24 if one of the output terminals PHASE_A_OUT, PHASE_B_OUT, PHASE_C_OUT were switched into electrical continuity with both the DC positive conductor VBUS+ and the DC negative conductor VBUS− of the DC bus 24.

As also shown in FIG. 5, the signal conditioner 50 includes a first AND gate 56 associated with each of the output terminals PHASE_A_OUT, PHASE_B_OUT, PHASE_C_OUT to produce a verified positive output PWM_x_DRV, where x is the corresponding one of A, B, or C, if both an associated one of the positive control outputs PWM_A_BUFF, PWM_B_BUFF, PWMC_BUFF is energized and the corresponding output OK signal 54 is also energized. Likewise, the signal conditioner 50 includes a second AND gate 58 associated with each of the output terminals PHASE_A_OUT, PHASE_B_OUT, PHASE_C_OUT producing a verified negative output PWM_x/_DRV, where x is the corresponding one of A, B, or C, if both an associated one of the negative control outputs PWM_A/_BUFF, PWM_B/_BUFF, PWM_C/_BUFF is energized and the corresponding output OK signal 54 is also energized. The verified positive outputs PWM_x_DRV are each used to trigger a corresponding one of the positive switches 32, 34, 36 to conduct current from the positive DC bus VBUS+ to a corresponding one of the output terminals PHASE_A_OUT, PHASE_B_OUT, PHASE_C_OUT, and the verified negative outputs PWM_x/_DRV, are each used to trigger a corresponding one of the negative switches 38, 40, 42 to conduct current to the negative DC bus VBUS− from a corresponding one of the output terminals PHASE_A_OUT, PHASE_B_OUT, PHASE_C_OUT.

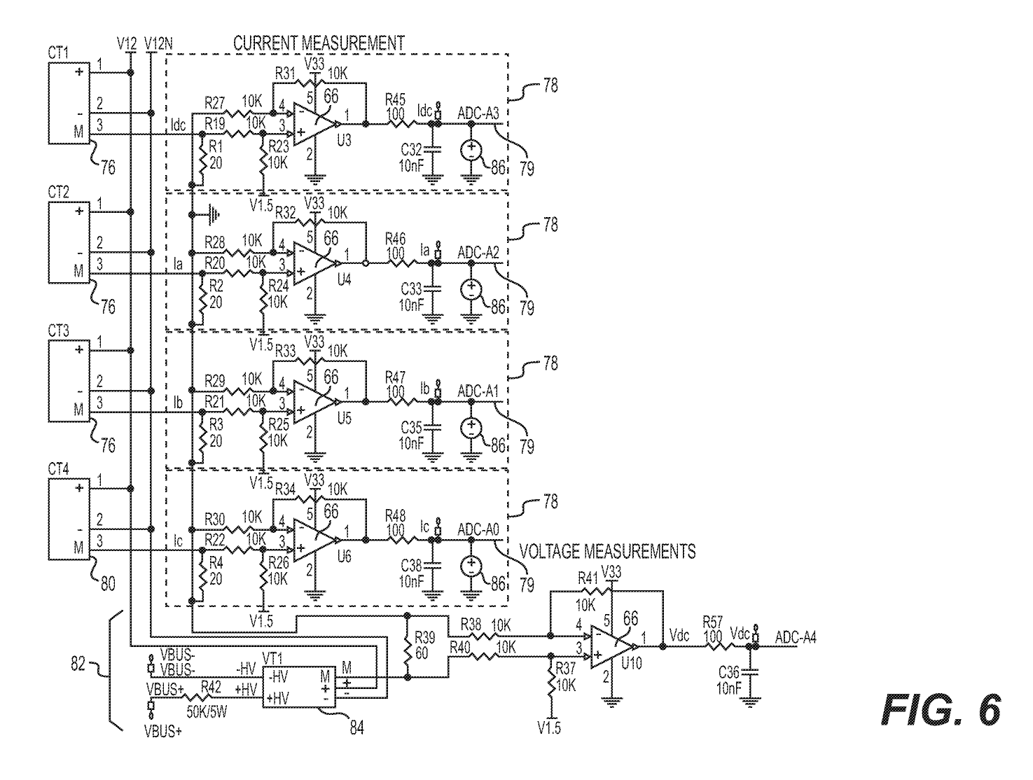

In some embodiments, and as shown in schematic form on FIG. 6, the motor drive 20 may include an AC current transmitter 76 in communication with a current transmitter monitoring circuit 78 for sensing the electrical current in each of the motor leads T1, T2, T3 and for communicating a value thereof to the controller 48. In other words, there may be a total of three AC current transmitters 76 and three current transmitter monitoring circuits 78. The motor drive 20 also includes a DC current transmitter 80 in communication with a current monitoring circuit 78 for sensing the electrical current in one of the DC supply leads 28 and for communicating a value thereof to the controller 48. In an example embodiment, the AC current transmitters 76 and the DC current transmitter 80 are each LA55P devices from LEM. The motor drive 20 also includes a voltage monitoring circuit 82 having a voltage transducer 84 for measuring the DC voltage of the DC bus 24 and for communicating a value thereof to the controller 48. In an example embodiment, the voltage transducer 84 is a LV25-P from LEM.

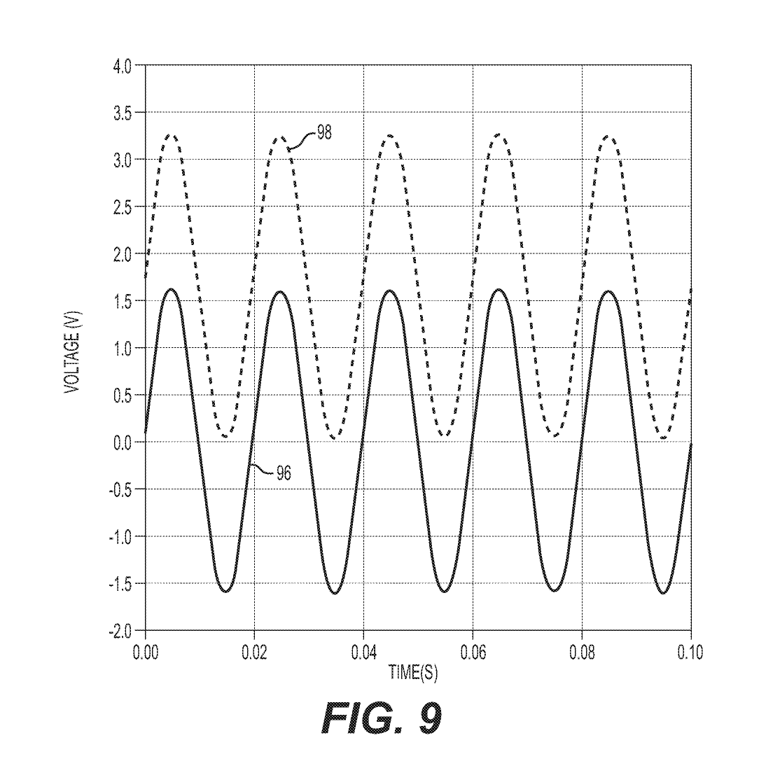

One or more of the current transmitter monitoring circuits 78 and/or the voltage monitoring circuit 82 may include a DC voltage source 86 for providing a DC offset to the output 79. The DC offset is described in detail, below, with reference to FIG. 9.

In some embodiments, and as illustrated on FIG. 7, a first alternative current monitoring circuit 78′ functions as an interface to an analog-to-digital converter (ADC) of the controller 48 by producing an output 79′ having a voltage proportional to the electrical current in a corresponding one of the motor leads T1, T2, T3. In other words, the motor drive 20 may include three of the alternative current monitoring circuits 78′, with each of the alternative current monitoring circuits 78′ allowing the controller 48 to monitor an amount of electrical current in a corresponding one of the motor leads T1, T2, T3. More specifically, the first alternative current monitoring circuit 78′ is configured measuring a voltage across a corresponding one of the second shunt resistors 43 (described above with reference to FIG. 1) to produce the output 79′, which is scaled to be measured by an analog-to-digital converter (ADC). The ADC may be integrated within the controller 48. Alternatively, the ADC may be provided in a separate device configured to communicate a corresponding digital value to the controller 48. In the first alternative current monitoring circuit 78′ shown in FIG. 7, an isolation barrier 64 provides electrical isolation between the high-voltage inputs and protects the controller 48 and other components in the first alternative current monitoring circuit 78′ from damage that may occur, for example, from transient voltages. The isolation barrier 64 may be a silicon isolation driver, such as an SI8920 by Silicon labs. However, it should be appreciated that the isolation barrier 64 may comprise one or more different devices to provide electrical isolation. The first alternative current monitoring circuit 78′ also includes an operational amplifier 66 that is configured to scale a voltage output from the isolated silicon amplifier 64 to a range suitable for being measured by an analog-to-digital converter (ADC) of the controller 48. The first alternative current monitoring circuit 78′ also includes a DC voltage source 86 for providing a DC offset to the output 79′. The DC voltage source 86 in the example embodiment includes a pair of schottky diodes connected in series between an earth ground and a positive 3.3 V rail V33. The DC offset is described in detail, below, with reference to FIG. 9.

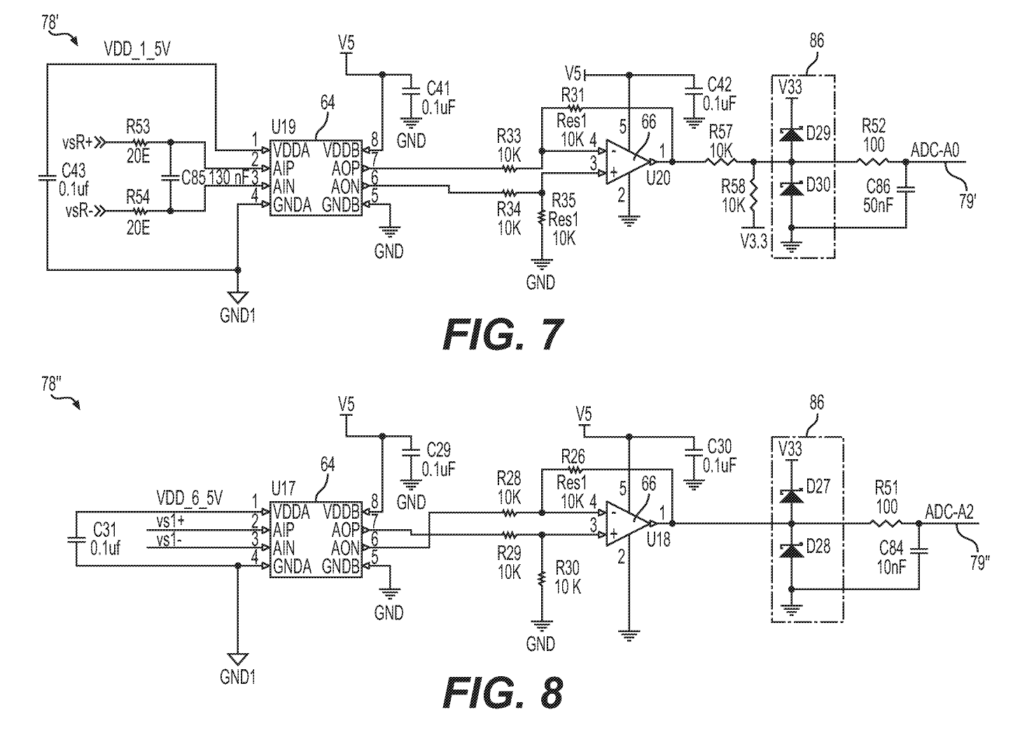

In some embodiments, and as illustrated on FIG. 8, a second alternative current monitoring circuit 78″ functions as an interface to an analog-to-digital converter (ADC) of the controller 48 by producing an output 79″ having a voltage proportional to the electrical current supplied to the motor drive 20 by the DC supply 27. The second alternative current monitoring circuit 78″ is similar in construction and operation to the first alternative current monitoring circuit 78′, described above. The second alternative current monitoring circuit 78″ may be configured to take as an input the voltage across the first shunt resistor 26, described above with reference to FIG. 1. The second alternative current monitoring circuit 78″ may, therefore, be used in measuring the electrical current provided to the motor controller 20 by the DC supply 27.

Each of the example current transmitter monitoring circuits 78 and the voltage monitoring circuit 82 shown on FIG. 6 and the alternative current monitoring circuits 78′, 78″, shown on FIGS. 7-8 includes an operational amplifier 66. In some example embodiments, one or more of the operational amplifiers 66 may be AD8615 devices by Analog Devices.

With reference to FIG. 9, a first output waveform 96 and a shifted output waveform 98 are provided. FIG. 9 illustrates an example embodiment showing the effect of the DC voltage source 86 to offset the output 79′ by a predetermined amount. In the example embodiment, the first output waveform 96 is a sinusoid having a mean value of 0.0 V and an amplitude of about 3.25 V. The shifted output waveform is offset by a constant value of about 1.6 V to cause the shifted output waveform to vary from about 0.0 V to about 3.3 V. The shifted output waveform 98 may, therefore, be accurately measured by an analog-to-digital converter (ADC) having a range of values from 0.0 V to some positive DC Voltage. For example, an ADC having a range of 0-3.3 V or 0-5.0 V would be able to measure the entire shifted output waveform 98, but not the negative voltages present in the original first output waveform 96.

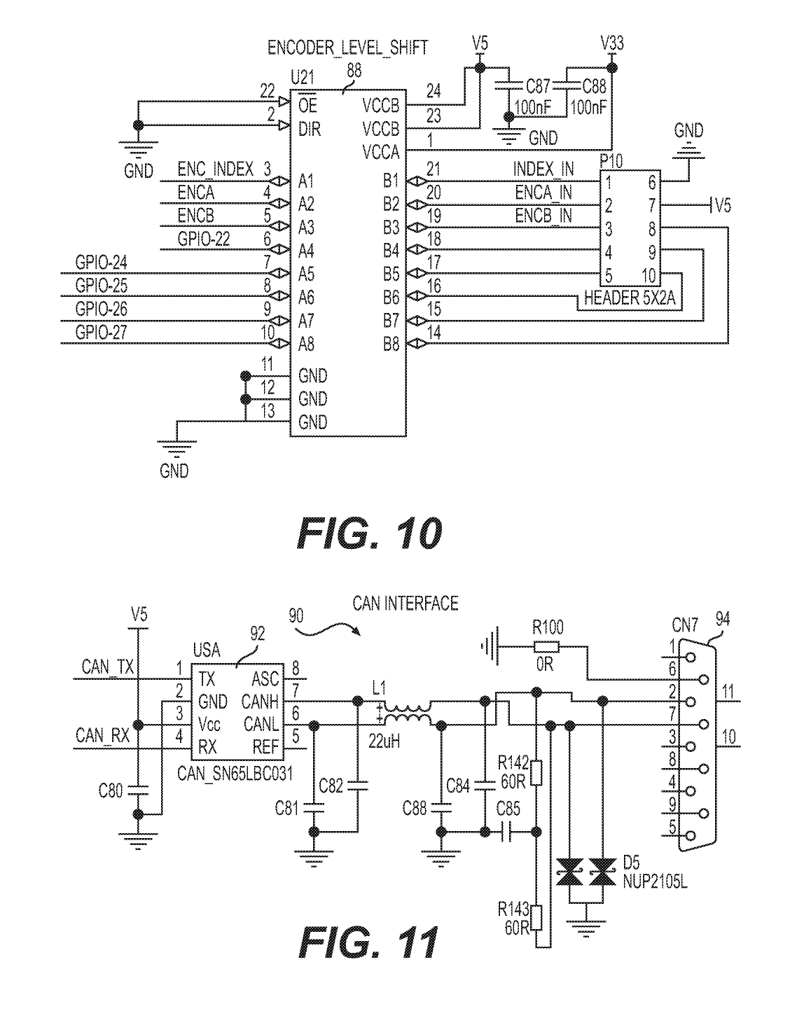

As shown in FIG. 10, the motor drive 20 may include a voltage level converter 88 for converting electrical signals from an encoder (not shown in the figures) to a format readable by general purpose I/O (GPIO) pins of the controller 48. In one example embodiment, the voltage level converter 88 is a SN74LVC245DW bus transceiver part by Texas Instruments. However, it should be appreciated that the voltage level converter 88 may be a different device. Encoders are commonly used with motor drive 20 for providing a feedback signal regarding the position and speed of the electric motor 22.

As shown in FIG. 11, the motor drive 20 may include a controller area network (CAN) interface 90 including a CAN transceiver 92 integrated circuit and a CAN connector 94 for providing communications between the controller 48 and external CAN devices. The CAN interface 90 may allow the motor drive 20 to communicate with other controller devices in a larger system such as, for example, with an ECU in a vehicle.

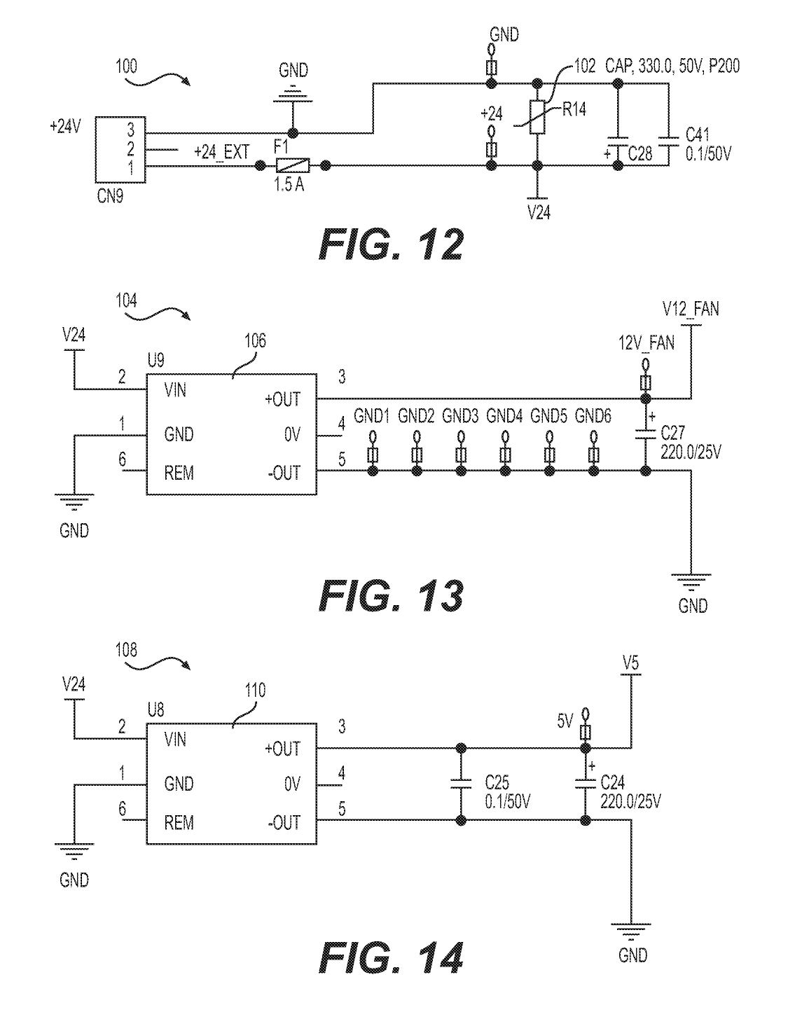

As shown in FIG. 12, the motor drive 20 may include a first voltage regulator circuit 100 including a Zener diode 102 for providing a regulated 24 VDC power supply V24 from an unregulated source of 24 VDC power +24V.

As shown in FIG. 13, the motor drive 20 may include a second voltage regulator circuit 104 including a first DC-DC converter 106 for generating 12 VDC power V12 for supplying electrical energy to the fans 72 from the regulated 24 VDC power supply V24 from the first voltage regulator circuit 100. In one example embodiment, the first DC-DC converter 106 is a PYB10 W-24--S12 part by CUI, Inc. However, it should be appreciated that the first DC-DC converter 106 may be a different part and/or a circuit comprising one or more parts.

As shown in FIG. 14, the motor drive 20 may include a third voltage regulator circuit 108 including a second DC-DC converter 110 for generating a regulated 5 VDC power V5 from the regulated 24 VDC power supply V24 from the first voltage regulator circuit 100. In one example embodiment, the second DC-DC converter 110 is a PYB20-Q24-S5 part by CUI, Inc. However, it should be appreciated that the second DC-DC converter 110 may be a different part and/or a circuit comprising one or more parts.

As shown in FIG. 15, the motor drive 20 may include a fourth voltage regulator circuit 112 including a third DC-DC converter 114 for generating a positive 12 V power line V12 and a negative 12 V power V12N from the regulated 24 VDC power supply V24 from the first voltage regulator circuit 100. In one example embodiment, the third DC-DC converter 114 is a PYB10 W-Q24-D12 part by CUI, Inc. However, it should be appreciated that the third DC-DC converter 114 may be a different part and/or a circuit comprising one or more parts.

As shown in FIG. 16, the motor drive 20 may include a fifth voltage regulator circuit 116 including a fourth DC-DC converter 118 for generating a positive 3.3 V power line V33 from the regulated 5 VDC power V5 from the third voltage regulator circuit 108. In one example embodiment, the fourth DC-DC converter 118 is a TPS79533DCQ part by Texas Instruments. However, it should be appreciated that the fourth DC-DC converter 118 may be a different part and/or a circuit comprising one or more parts.

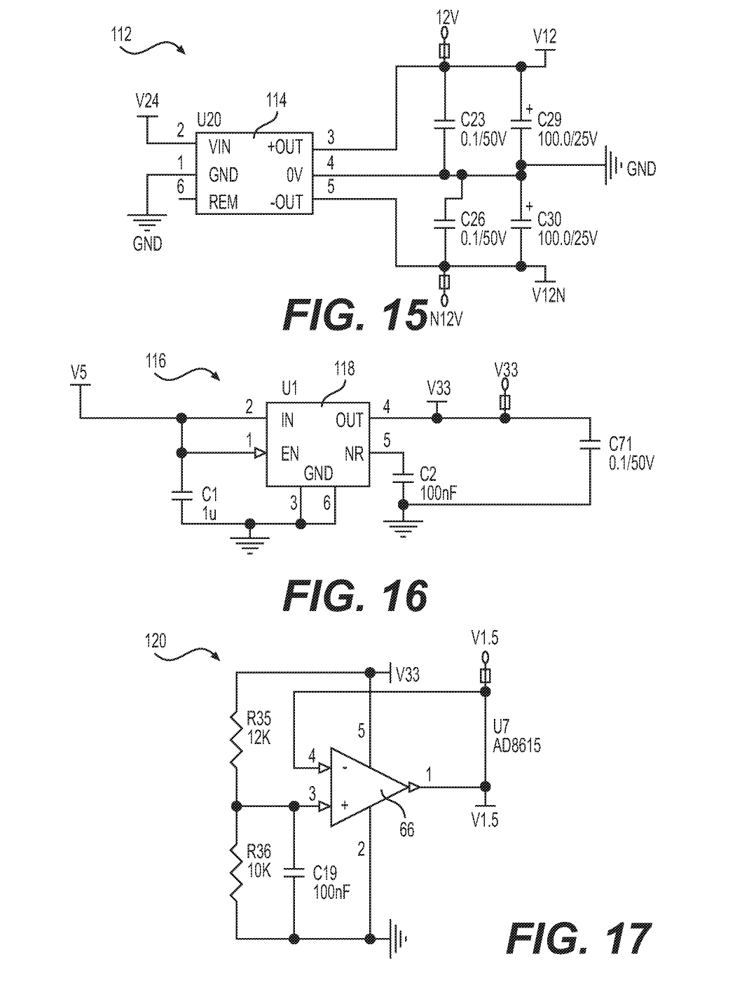

As shown in FIG. 17, the motor drive 20 may include a sixth voltage regulator circuit 120 including an operational amplifier 122 for generating a positive 1.5 V power line from the positive 3.3 V power line V33 from the fifth voltage regulator circuit 116.

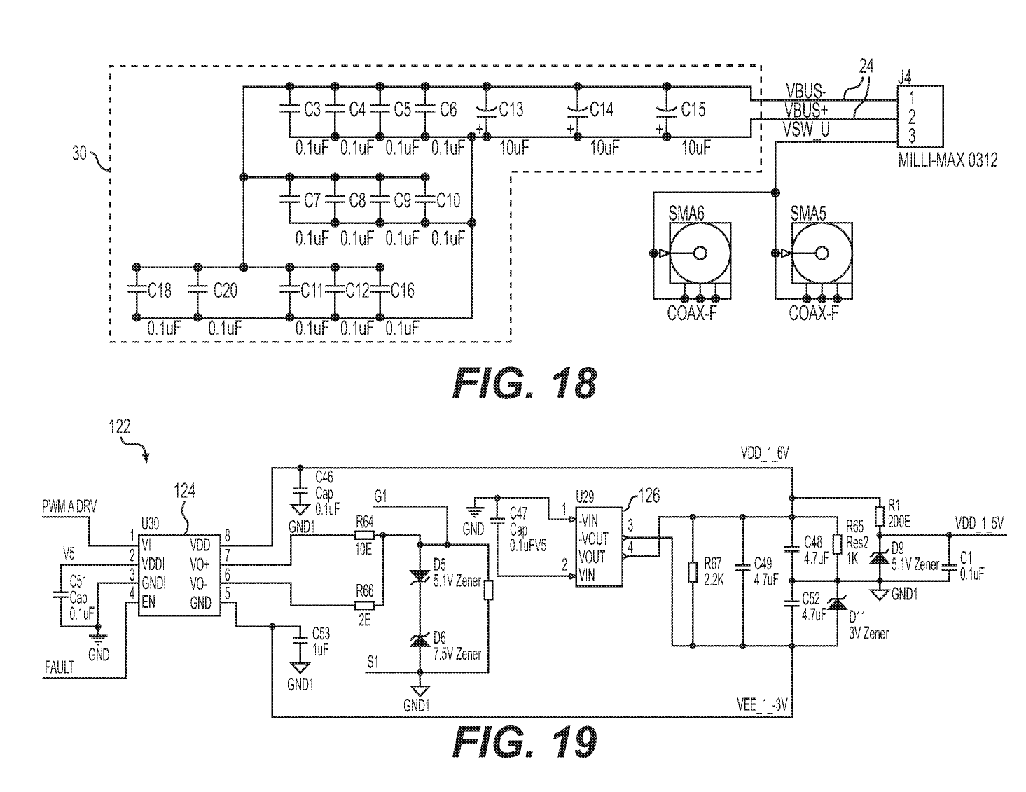

As shown in FIGS. 1, 2A, and schematically in FIG. 18, a plurality of capacitors 30 are connected across the DC bus 24. The capacitors 30 function to stabilize the DC voltage across the DC bus 24. For example, the capacitors 30 may supply relatively large inrush currents when the power switches 32, 34, 36, 38, 40, 42 are switched on to conduct current to a corresponding one of the output terminals.

Referring now to FIG. 19, an example positive gate driver circuit 122 for controlling one of the power switches 32, 34, 36, 38, 40, 42 is shown. The positive gate driver circuit 122 accepts as in input a first verified positive output PWM_A_DRV and produces a gate control output G1 and a source control output S1 for controlling the first positive switch 32. The gate driver circuit 122 includes a silicon isolator 124, which may be a SI8271 driver isolator from Silicon Labs, and which provides electrical isolation between the signal conditioner 50 and the one of the power switches 32, 34, 36, 38, 40, 42 being controlled. The gate driver circuit 122 also includes a DC-DC converter 126 to provide a regulated DC power source to the silicon isolator 124 from the regulated 5 VDC power V5. The DC-DC converter 126 may be, for example, a MEU1S0509ZC part from Murata Power Solutions Inc. It should be appreciated that the silicon isolator 124 and/or the DC-DC converter 126 may be provided using different part and/or circuits comprising one or more parts.

Referring now to FIG. 20, an example single-phase switching circuit is illustrated. The single-phase switching circuit includes a positive switching transistor S_{Pos} configured to switch the positive conductor VBUS+ of the DC bus 24 to an output terminal PHASE_A_OUT. The single-phase switching circuit also includes a negative switching transistor S_{Neg} configured to switch the negative conductor VBUS− of the DC bus 24 to the output terminal PHASE_A_OUT. In one example embodiment, the positive switching transistor S_{Pos} is the first positive switch 32, described above, and the negative switching transistor S_{Neg} is the first negative switch 34, described above. However, the operation described below may be applied to different phases, or different embodiments of the motor drive 20. As shown in the schematic of FIG. 20, a neutral node n is connected to an earth ground, with the positive conductor VBUS+ of the DC bus 24 having a voltage of +(V_{dc}/2) relative to the neutral node n, and with the negative conductor VBUS− of the DC bus 24 having a voltage of −(V_{dc}/2) relative to the neutral node n, where V_{dc} is the DC voltage across the DC bus 24.

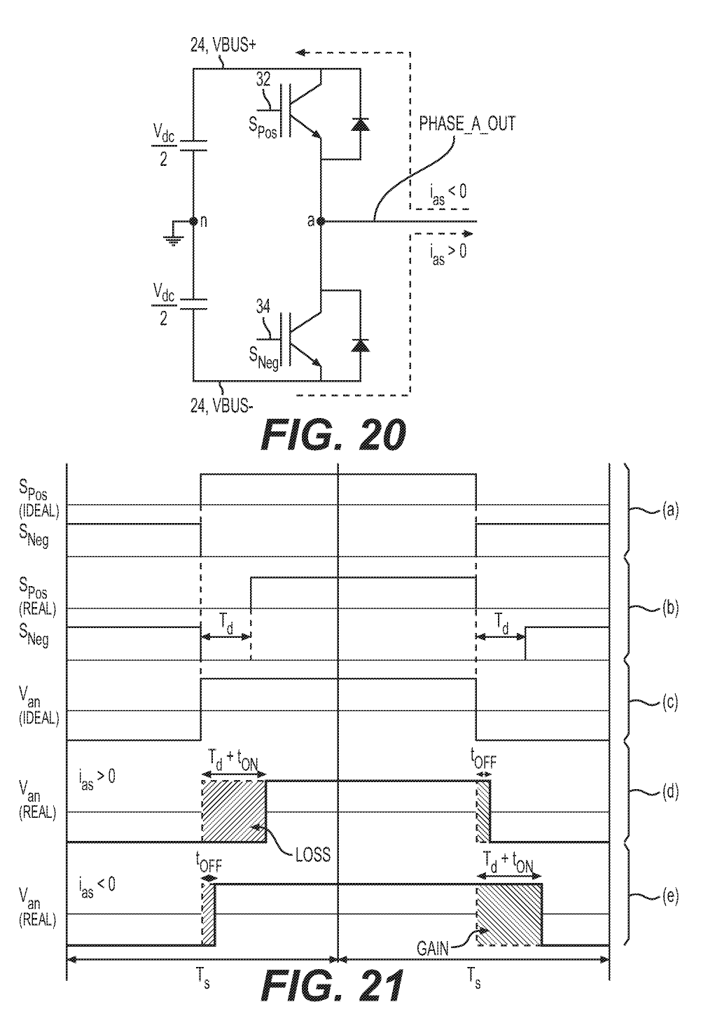

Referring now to FIG. 21, a timing diagram shows the switching patterns and output voltages of the positive switching transistor S_{Pos} and the negative switching transistor S_{Neg} described above with reference to FIG. 20. The first (a) graph of FIG. 21 shows an ideal gating pattern of the positive and negative switching transistors S_{Pos}, S_{Neg}, with each of the switching transistors beginning to conduct electrical current immediately upon the other one of the switching transistors stopping conducting electrical current. An ideal a-phase voltage Vₐₙ, which is the voltage on node a, relative to the neutral node n of FIG. 21 is shown in graph (c).

However, real-world devices cannot switch on or off immediately. Real-world switching transistors have a turn-on time t_{ON} between when they are commanded on and when they are substantially conductive. Real-world switching transistors also have a turn-off time t_{OFF} between when they are commanded off and when they cease to be substantially conductive. Therefore, a delay time Td must be used between commanding each of the switching transistors S_{Pos}, S_{Neg} to begin conducting electrical current after the other one of the switching transistors is commanded to stop conducting electrical current. This delay time T_{d} is critical to ensure that each of the switching transistors S_{Pos}, S_{Neg} of a given phase circuit are not both substantially conductive at the same time, which would result in a short circuit and potential damage to the motor drive 20. A real gating pattern, which includes the delay time T_{d}, is illustrated in the graph (b) of FIG. 21.

Graph (d) of FIG. 21 illustrates the a-phase voltage Vₐₙ over time while the current supplied the output terminal PHASE_A_OUT is positive. Graph (e) of FIG. 21 illustrates the a-phase voltage Vₐₙ over time while the current supplied the output terminal PHASE_A_OUT is negative. In other words, graphs (d) and (e) of FIG. 21 explain the effect of dead time with respect to direction of current through the phase. It explains the average voltage loss at turning on during positive current, shown in graph (d), and average voltage gain during negative current flow, shown in graph (e). The falling edge during the positive current, shown in graph (d) gains very little amount of turn-off time t_{OFF}. Similarly, the rising edge loses very little amount of turn-on time t_{ON} during negative current, shown in graph (e). This effect can be quantified as an average distorted voltage ΔV, according to the direction of the a-phase current as expressed in equations (1) and (2), below, where T_{d} is the dead time, Tₛ is the switching period of the switching transistors S_{Pos}, S_{Neg}, and t_{ON} and t_{OFF} are turn-on time and turn-off time of the switching transistors S_{Pos}, S_{Neg}:

$$\begin{matrix}Δ V = \frac{- {T}_{d} - {t}_{ON} + {t}_{OFF}}{2 {T}_{s}} {V}_{dc} , {i}_{as} > 0 & ( 1 ) \\ Δ V = \frac{{T}_{d} + {t}_{ON} - {t}_{OFF}}{2 {T}_{s}} {V}_{dc} , {i}_{as} < 0 & ( 2 )\end{matrix}$$

In other words, the average distorted voltage ΔV is proportional to an absolute value of the dead time T_{d} plus the turn-on time t_{ON} minus the turn-off time t_{OFF}, as illustrated in the numerators of each of equations (1) and (2), above. In some embodiments, particularly where the switching transistors S_{Pos}, S_{Neg} are GaN devices, the dead time T_{d} plus the turn-on time t_{ON} minus the turn-off time t_{OFF} is less than 300 ns and the switching frequency is between 30 kHz and 50 kHz. In other words, the ratio of (the dead time T_{d} plus the turn-on time t_{ON} minus the turn-off time t_{OFF}) to the switching time Tₛ may be between 9*10⁻³ and 15*10⁻³. This ratio comes from equation (2), above.

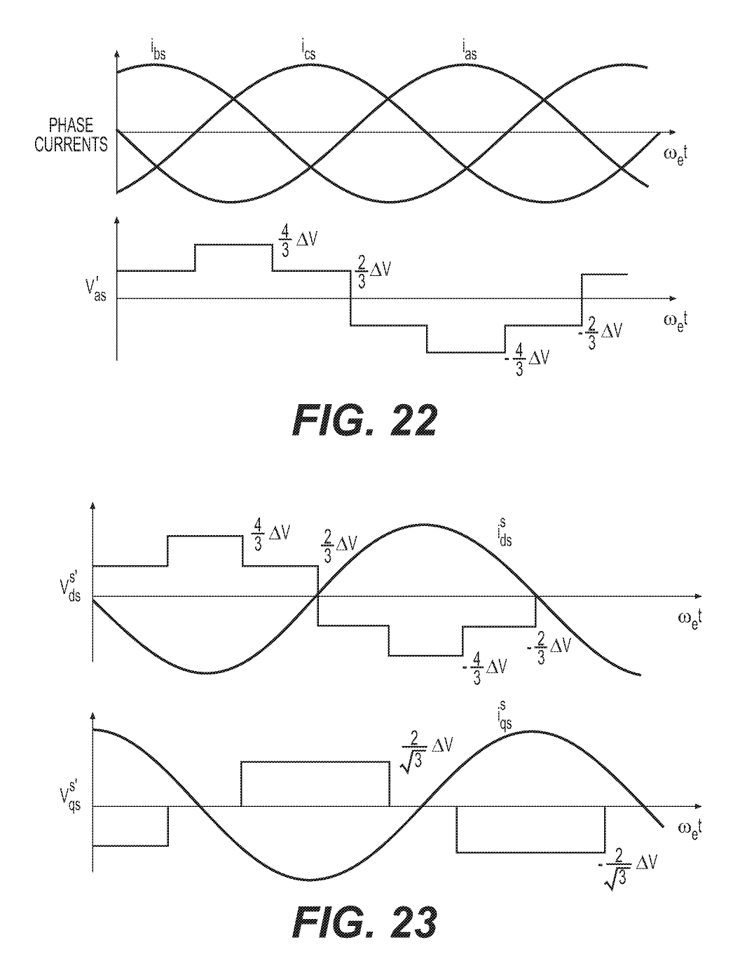

FIG. 22 shows the distorted a-phase voltage V′ₐₛ relative to three-phase currents iₐₛ, i_{bs}, and i_{cs}. FIG. 23 shows the distorted voltages V_{ds}^{s′} and V_{qs}^{s′} and dq-axes currents i_{qs}^{s} and i_{ds}^{s} at the stationary coordinate. Equations (4) and (5), below, show the Fourier series expansion of the distorted voltages V_{ds}^{s′} and V_{qs}^{s′} shown in FIG. 23.

$$\begin{matrix}{v}_{ds}^{{s}^{′}} = \frac{4}{π} Δ V \{ sin {ω}_{e} t + \frac{1}{5} sin 5 {ω}_{e} t + \frac{1}{7} sin 7 {ω}_{e} t + \frac{1}{11} sin 11 {ω}_{e} t + \frac{1}{13} sin 13 {ω}_{e} t + … \} & ( 4 ) \\ {v}_{qs}^{{s}^{′}} = \frac{4}{π} Δ V \{ - cos {ω}_{e} t + \frac{1}{5} cos 5 {ω}_{e} t - \frac{1}{7} cos 7 {ω}_{e} t + \frac{1}{11} cos 11 {ω}_{e} t - \frac{1}{13} cos 13 {ω}_{e} t + … \} . & ( 5 )\end{matrix}$$

Considering a balanced three-phase load, the distorted d and q-axis currents i_{qs}^{s} and i_{ds}^{s} of the stationary reference frame can be expressed as shown in Equations (6), (7) and (8), below.

$$\begin{matrix}{i}_{ds}^{{s}^{′}} = \frac{4}{π} \frac{Δ V}{{Z}_{L}} \{ sin ( {ω}_{e} t - φ ) + \frac{1}{5} sin 5 ( {ω}_{e} t - φ ) + \frac{1}{7} sin 7 ( {ω}_{e} t - φ ) \} + \frac{4}{π} \frac{Δ V}{{Z}_{L}} \{ \frac{1}{11} sin 11 ( {ω}_{e} t - φ ) + \frac{1}{13} sin 13 ( {ω}_{e} t - φ ) + … \} & ( 6 ) \\ {i}_{qs}^{{s}^{′}} = \frac{4}{π} \frac{Δ V}{{Z}_{L}} \{ - cos ( {ω}_{e} t - φ ) + \frac{1}{5} cos 5 ( {ω}_{e} t - φ ) - \frac{1}{7} cos 7 ( {ω}_{e} t - φ ) \} + \frac{4}{π} \frac{Δ V}{{Z}_{L}} \{ \frac{1}{11} cos 11 ( {ω}_{e} t - φ ) - \frac{1}{13} cos 13 ( {ω}_{e} t - φ ) + … \} & ( 7 ) \\ {Z}_{k} = \vert {R}_{s} + j k {ω}_{e} {L}_{s} \vert = \sqrt{{R}_{s}^{2} + {( k {ω}_{e} {L}_{s} )}^{2}} & ( 8 )\end{matrix}$$

From the above equations (6) and (7), it is clear that the dq-axes currents i_{qs}^{s} and i_{ds}^{s} at the stationary coordinate contain 5^{th} and 7^{th} order harmonics are directly proportional to ΔV. For switching transistors S_{Pos}, S_{Neg} having a turn-on time t_{ON} and turn-off time t_{OFF} that are substantially shorter than the dead time T_{d}, such as the Gallium Nitride (GaN) power switches used in the subject motor drive 20, described above, ΔV is substantially proportional to the dead time T_{d}. With such high-speed switching transistors, the 5^{th} and 7^{th} order harmonics are approximately proportional to the dead time T_{d}. Therefore, the the dead time T_{d} can be optimized to minimize the harmonics in the distortion currents i_{qs}^{s} and i_{ds}^{s}.

In one numerical example, a fifth-order harmonic distortion current I_{s,5} is calculated for a motor drive 20 with a dead time T_{d} of 3 μs, a DC bus voltage of 200 VDC, a switching frequency of 20 kHz, a turn-on time t_{ON} of 17 ns, and a turn-off time t_{ON} of 37 ns. From equations (6) and (7), above, the RMS component is calculated for alpha and beta axes currents, then it is transformed into three phase quantity, I_{s,5}=sqrt [(i_{ds5}^{s})²+(i_{qs5}^{s})²]*(2/3), where i_{ds5}^{s}=i_{qs5}^{s}=(4*ΔV)/(57*1.414*Z5)=(2*1.414*ΔV/(5π*Z5)). Therefore, I_{s,5}=(2*1.414*ΔV/(5π*Z5))*1.414*(2/3)=416 mA. In experimental results, the fifth-order harmonic distortion current, I_{s,5} with the same parameters was found to be 104 mA. In another numerical example, keeping the parameters above, except dead time T_{d}, which is changed to 300 ns, I_{s,5}=(2*1.414*ΔV/(5π*Z5))*1.414*(2/3)=42 mA. In corresponding experimental results, the fifth-order harmonic distortion current, I_{s,5} was found to be 32 mA.

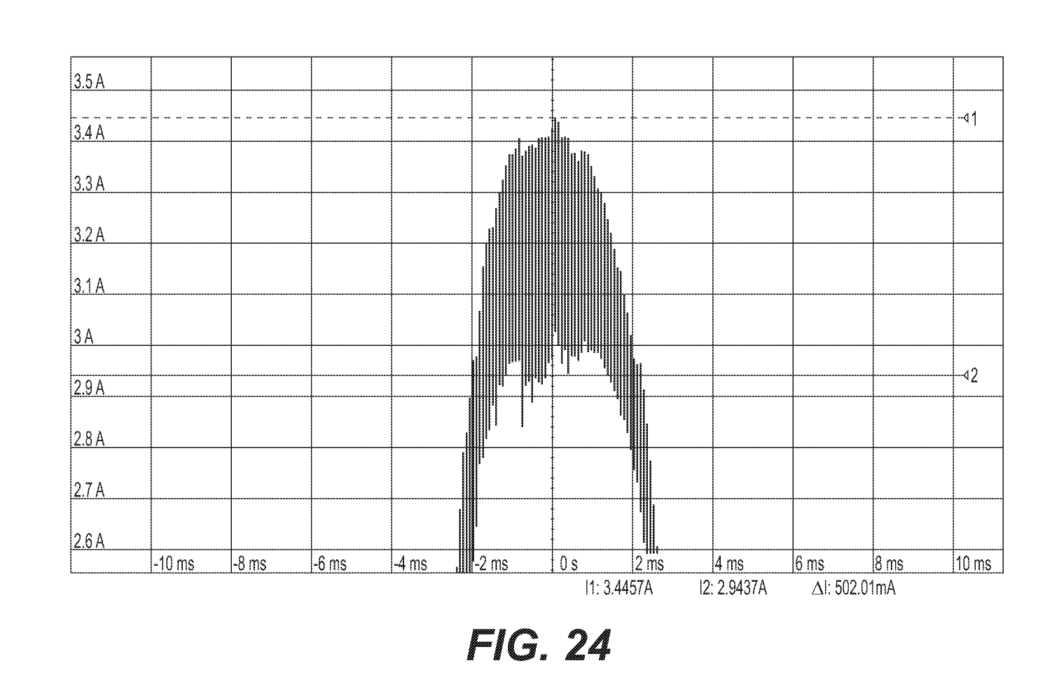

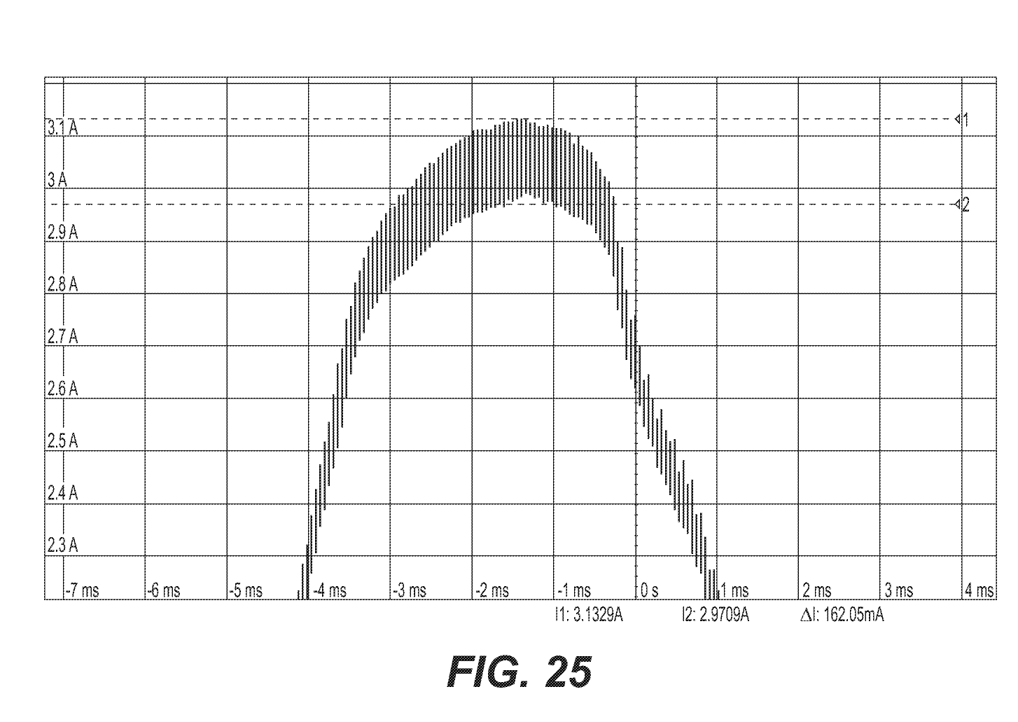

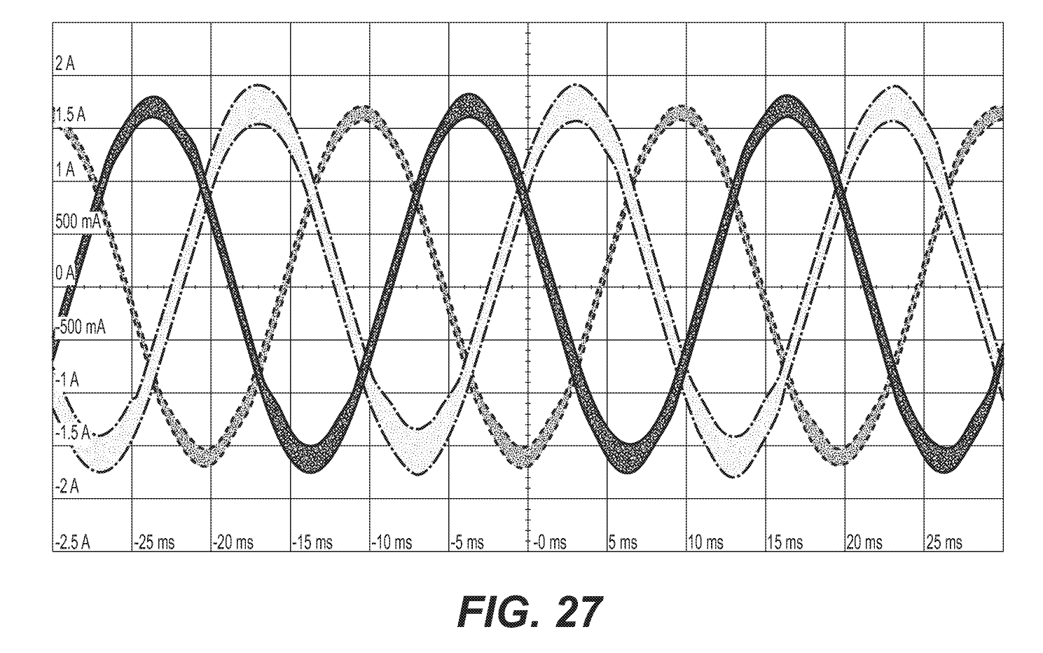

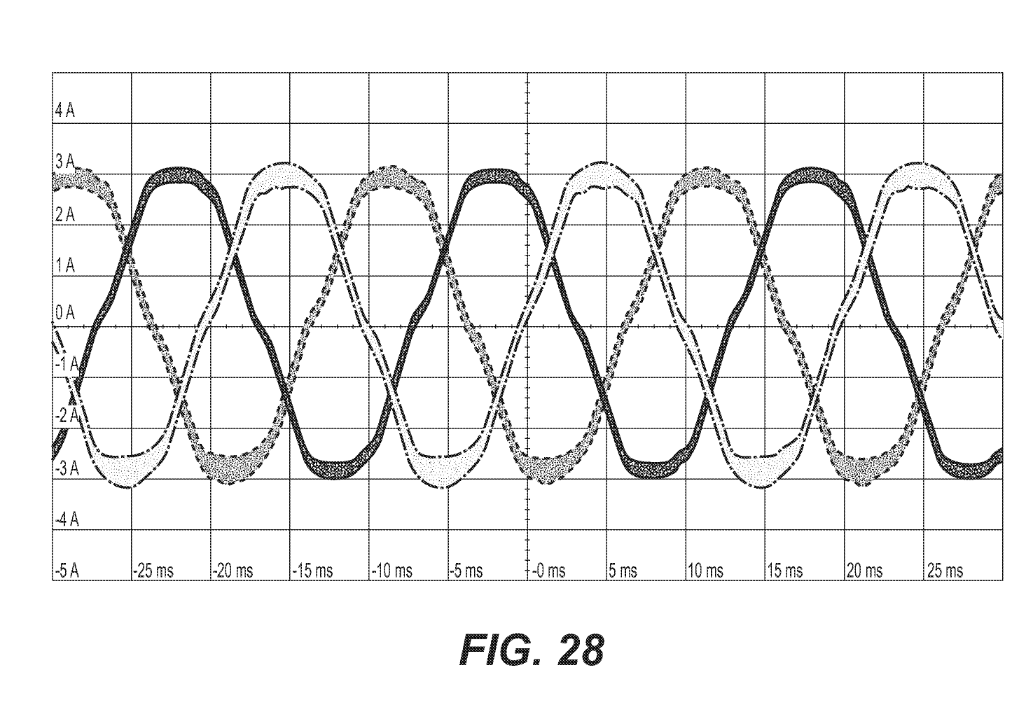

Referring now to FIG. 24, a single-phase output current of a motor drive 20 with a dead time T_{d} of 3 μs, a DC bus voltage of 200 VDC, and a switching frequency of 10 kHz is shown. The horizontal pointer lines (labeled 1, and 2) are positioned show the current ripple ΔI, which measures about 502 mA. FIG. 25 shows a single-phase output of a motor drive 20 having the same values as in FIG. 27, but with the switching frequency increased to 100 kHz. As shown on FIG. 28, the current ripple ΔI is reduced to about 162 mA.

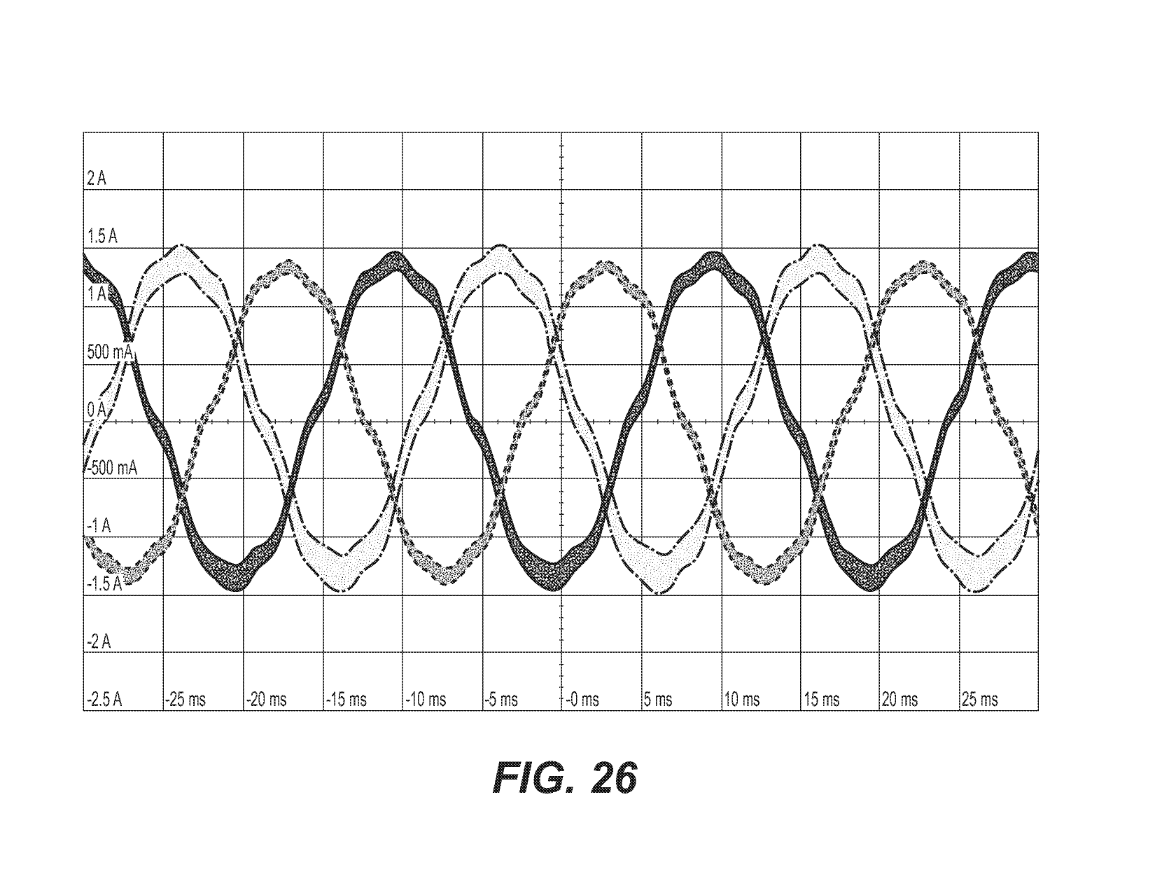

Referring now to FIG. 26, a three-phase output current of a motor drive 20 with a fundamental frequency of 50 Hz, a dead time T_{d} of 3 μs, a DC bus voltage of 200 VDC, and a switching frequency of 100 kHz is shown. FIG. 26 shows current distortions in the shapes of each waveform which deviate from sinusoids near the respective zero-crossings and before and after each respective maximum and minimum. These distortions are caused by the 5^{th} and 7^{th} order harmonics, discussed above. FIG. 27 shows a three-phase output of a motor drive 20 having the same values as in FIG. 26, but with the dead time T_{d} reduced to 300 ns. The reduced dead time T_{d} to switching time Tₛ shown in FIG. 27 substantially eliminates the current distortions without changing the switching frequency. In other words, the dead time T_{d} of 300 ns, which is possible using Gallium Nitride (GaN) power switches 32, 34, 36, 38, 40, 42, but which is not possible using other types devices, such as insulated-gate bipolar transistors (IGBTs) used in conventional motor drives, helps to reduce low frequency harmonic losses and switching frequency harmonic losses.

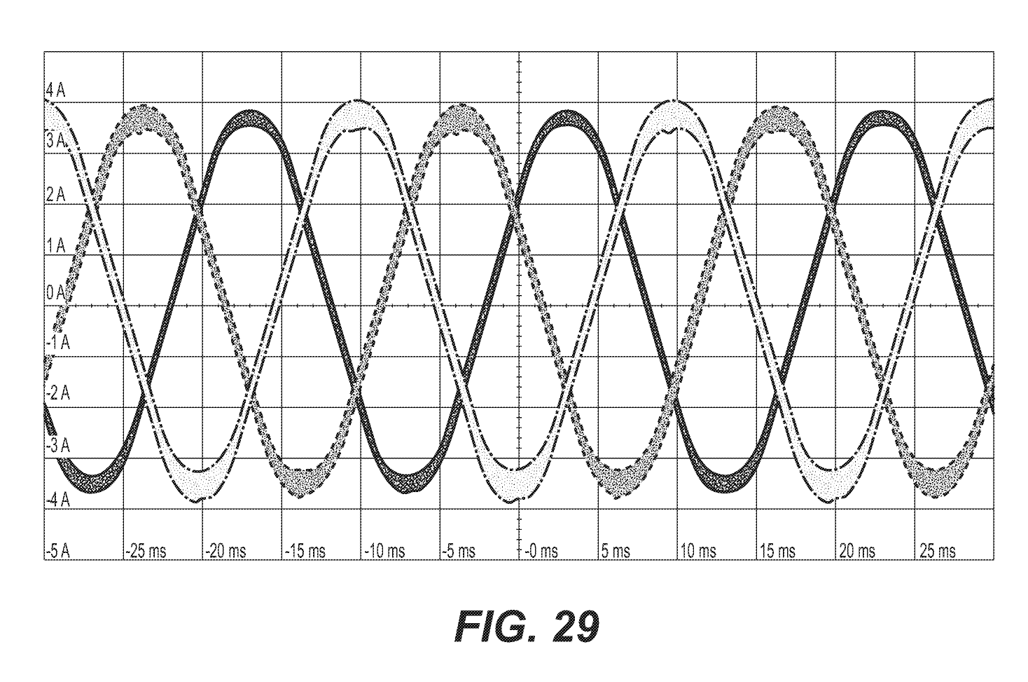

Referring now to FIG. 28, a three-phase output current of a motor drive 20 with a fundamental frequency of 50 Hz, a dead time T_{d} of 3 μs, a DC bus voltage of 200 VDC, and a switching frequency of 20 kHz is shown. Similarly to FIG. 26, discussed above, FIG. 28 shows current distortions in the shapes of each waveform which deviate from sinusoids near the respective zero-crossings and before and after each respective maximum and minimum. These distortions are caused by the 5^{th} and 7^{th} order harmonics, discussed above. FIG. 29 shows a three-phase output of a motor drive 20 having the same values as in FIG. 28, but with the dead time T_{d} reduced to 300 ns. The reduced dead time T_{d} to switching time Tₛ shown in FIG. 29 substantially eliminates the current distortions without changing the switching frequency. Specifically, the most dominant low-frequency harmonic (the 5th harmonic) is reduced by a factor of 5, (from 110 mA to 30 mA) by reducing the dead time T_{d} from 3 μs to 300 ns. In other words, the dead time T_{d} of 300 ns, which is possible using Gallium Nitride (GaN) power switches 32, 34, 36, 38, 40, 42, but which is not possible using other types devices, such as insulated-gate bipolar transistors (IGBTs) used in conventional motor drives, results in a drastic reduction in low frequency harmonic losses and switching frequency harmonic losses.

It should be appreciated that the above graphs and associated values are merely exemplary, and that the subject invention may be practiced using one or more different parameter values, such as the fundamental frequency, dead time bus voltage, and/or switching frequency.

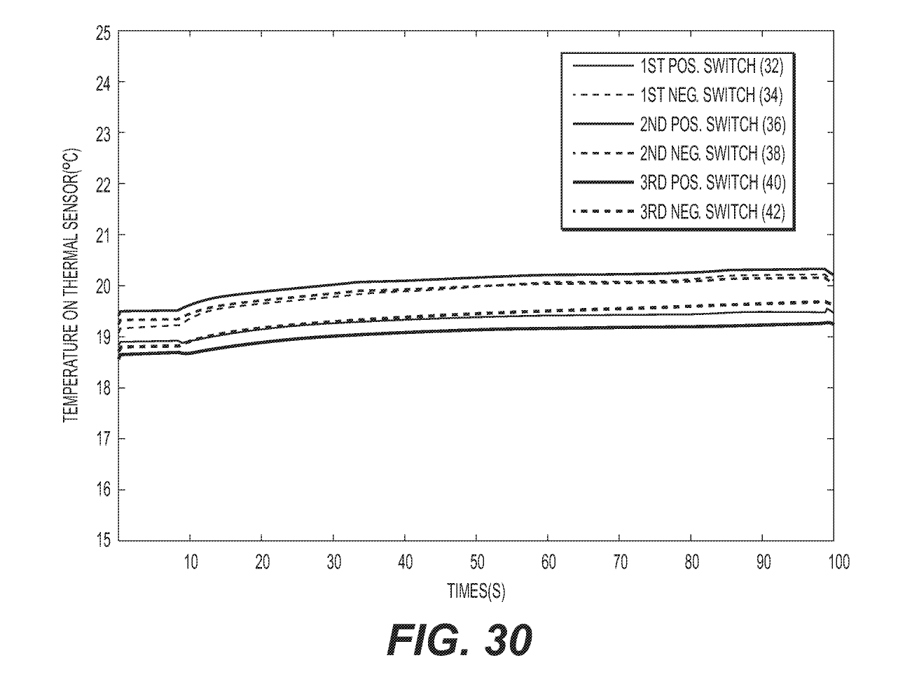

Referring now to FIG. 30, a graph of temperatures of the Gallium Nitride (GaN) power switches 32, 34, 36, 38, 40, 42 over time is shown. More specifically, the graph shows the temperatures of the power switches 32, 34, 36, 38, 40, 42 with air cooling, all reaching thermal stability at about 20 C with 2.3 A of load current and with a DC bus voltage of 200 VDC. This result shows the feasibility of the subject motor drive 20 with power switches 32, 34, 36, 38, 40, 42 that are air cooled. In other words, the power switches 32, 34, 36, 38, 40, 42 may not require active cooling, such as chilled water circulation, in order to operate the motor drive 20.

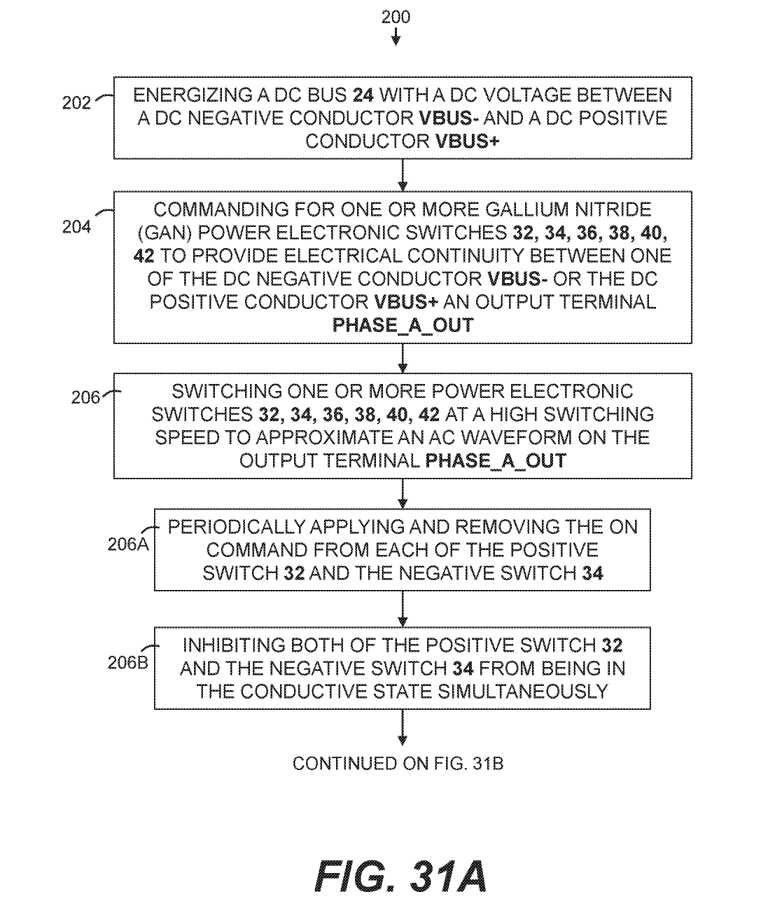

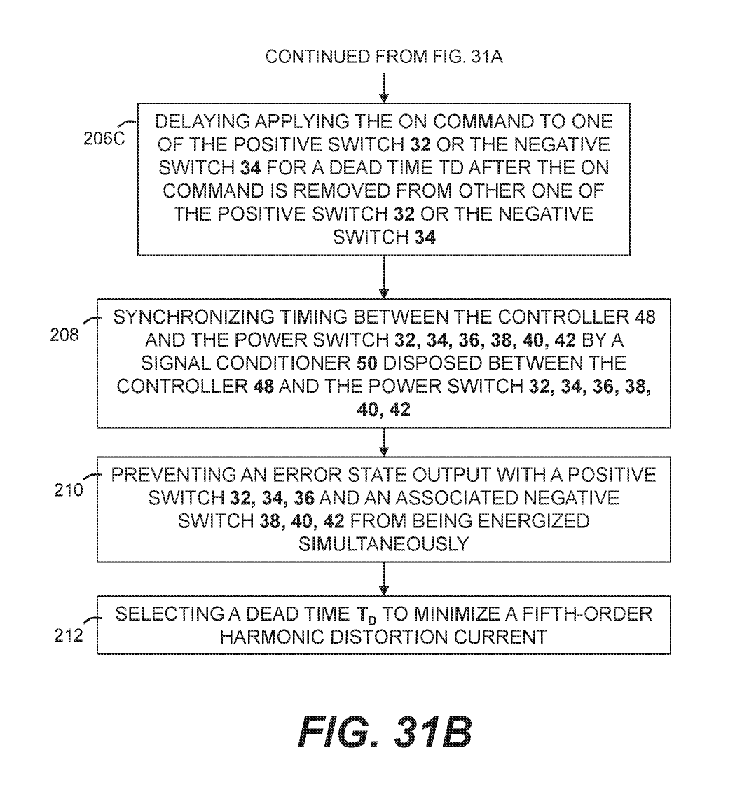

As shown in the flow chart of FIGS. 31A-31B, a method 200 for operating a motor drive to provide AC power to an electric motor is also provided. The method 200 includes energizing a DC bus 24 with a DC voltage between a DC negative conductor VBUS− and a DC positive conductor VBUS+ at step 202. Step 202 may be performed using a DC supply 27, which may be, for example, a battery pack, a DC generator, or a rectifier producing the high DC voltage from an AC source such as a utility line, or from an AC generator.

The method 200 includes commanding for one or more Gallium Nitride (GaN) power electronic switches 32, 34, 36, 38, 40, 42 to provide electrical continuity between one of the DC negative conductor VBUS− or the DC positive conductor VBUS+ an output terminal PHASE_A_OUT at step 204. The electrical current provided to the output terminal may provide AC power to drive an electric motor 22.

The method 200 includes switching one or more power electronic switches 32, 34, 36, 38, 40, 42 at a high switching speed to approximate an AC waveform on the output terminal PHASE_A_OUT at step 206. In some embodiments, a pulse width modulation (PWM) strategy is used in switching the one or more power electronic switches 32, 34, 36, 38, 40, 42 to approximate the AC waveform. In some embodiments, the high switching speed is between 10 kHz and 100 kHz. In some embodiments, the high switching speed is between 30 kHz and 500 kHz.

In some embodiments, the one or more power electronic switches 32, 34, 36, 38, 40, 42 includes a positive switch 32 and a negative switch 34, with the positive switch 32 responsive to an on command to be in a conductive state allowing electrical current to pass between the DC positive conductor VBUS+ and the output terminal PHASE_A_OUT, and with the negative switch 34 responsive to an on command to be in a conductive state allowing electrical current to pass between the DC negative conductor VBUS− and the output terminal PHASE_A_OUT.

With such a configuration that includes both a positive switch 32 and a negative switch 34, the method 200 may include periodically applying and removing the on command from each of the positive switch 32 and the negative switch 34 at step 206A. The method 200 may also include inhibiting both of the positive switch 32 and the negative switch 34 from being in the conductive state simultaneously at step 206B. The method 200 may include delaying applying the on command to one of the positive switch 32 or the negative switch 34 for a dead time T_{d} after the on command is removed from other one of the positive switch 32 or the negative switch 34 at step 206C.

The method 200 may also include synchronizing timing between the controller 48 and the power switch 32, 34, 36, 38, 40, 42 by a signal conditioner 50 disposed between the controller 48 and the power switch 32, 34, 36, 38, 40, 42 at step 208.

The method 200 may also include preventing an error state output with a positive switch 32, 34, 36 and an associated negative switch 38, 40, 42 from being energized simultaneously at step 210. In some embodiments, step 210 may be performed by a signal conditioner 50 disposed between the controller 48 and the power switches 32, 34, 36, 38, 40, 42.

In some embodiments, the method 200 includes selecting a dead time T_{d} to minimize a fifth-order harmonic distortion current at step 212. In some embodiments, the fifth-order harmonic distortion current may be reduced to a value between 5% and 1.2% of the fundamental component current, which is the current at the fundamental frequency. In some embodiments, the fifth-order harmonic distortion current may be reduced to a value less than 1.0% of the fundamental component current. In some embodiments, the fifth-order harmonic distortion current may be less than about 30 mA.

The controller and its related methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A motor drive for providing AC power to an electric motor comprising:
a DC bus including a DC negative conductor and a DC positive conductor having a DC voltage therebetween;
a capacitor connected across the DC bus for stabilizing the DC voltage;
an output terminal for connection of a motor lead to supply AC power to the electric motor;
one or more power electronic switches for selectively conducting electrical current between one of the DC positive conductor or the DC negative conductor and the output terminal;
wherein each of the one or more power electronic switches are Gallium Nitride (GaN) power switches; and
a controller in communication with each of the one or more power electronic switches for coordinating activation thereof at a high switching speed and for approximating an AC waveform on the output terminal.

2. The motor drive as set forth in claim 1 wherein the high switching speed is between 10 kHz and 100 kHz.

3. The motor drive as set forth in claim 1 wherein the high switching speed is between 30 kHz and 500 kHz.

4. The motor drive as set forth in claim 1, wherein the one or more power electronic switches includes a positive switch and a negative switch, with the positive switch responsive to an on command to change from a non-conductive state blocking electrical current to a conductive state allowing electrical current to pass between the DC positive conductor and the output terminal, and with the negative switch responsive to an on command to change from a non-conductive state blocking electrical current to a conductive state allowing electrical current to pass between the DC negative conductor and the output terminal.

5. The motor drive as set forth in claim 4, further including a signal conditioner disposed between the controller and each of the positive switch and the negative switch to prevent the on command from being simultaneously provided to each of the positive switch and the negative switch to prevent an error state output with each of the positive switch and the negative switch simultaneously being in the conductive state.

6. The motor drive as set forth in claim 4, further including a delay timer configured to provide a dead time as a delay between the on command being provided to one of the positive switch or the negative switch after the on command is removed from other one of the positive switch or the negative switch.

7. The motor drive as set forth in claim 6, wherein each of the power electronic switches has a turn-on time as a length of time between the on command being applied thereto until the power electronic switch is in the conductive state;
wherein each of the power electronic switches has a turn-off time as a length of time between the on command being removed therefrom until the power electronic switch is in the non-conductive state; and
wherein each of the turn-on time and the turn-off time of each of the power electronic switches is substantially shorter than the dead time.

8. The motor drive as set forth in claim 7, wherein the dead time plus the turn-on time minus the turn-off time is less than 300 ns.

9. The motor drive as set forth in claim 7, wherein the AC power supplied from the output terminal has a fundamental component current at a fundamental frequency;
wherein the motor drive produces a fifth-order harmonic distortion current upon the AC power supplied from the output terminal, with the fifth-order harmonic distortion current being proportional to an average distorted voltage;
wherein the average distorted voltage is proportional to an absolute value of the dead time plus the turn-on time minus the turn-off time; and
wherein the dead time is selected to cause the fifth-order harmonic distortion to be between 1.2% and 5.0% of the fundamental component current.

10. The motor drive as set forth in claim 1, further comprising a current monitoring circuit for sensing the amount of electrical current supplied to the electric motor from the output terminal;
wherein the current monitoring circuit comprises includes an operational amplifier to provide an analog input of the controller with a signal representative of the electrical current supplied to the electric motor from the output terminal; and
a DC voltage source coupled to an output of the operational amplifier to provide a DC offset to the analog input of the controller to maintain the signal representative of the electrical current supplied to the electric motor from the output terminal within a voltage range resolvable by the analog input of the controller.

11. A motor drive for providing AC power to an electric motor and comprising:
a DC bus including a DC negative conductor and a DC positive conductor having a DC voltage therebetween;
a capacitor connected across the DC bus for stabilizing the DC voltage;
an output terminal for connection of a motor lead to supply AC power to the electric motor;
one or more power electronic switches for selectively conducting electrical current between one of the DC positive conductor or the DC negative conductor and the output terminal;
wherein each of the one or more power electronic switches are Gallium Nitride (GaN) power switches; and
wherein each of the one or more power electronic switches are air cooled.

12. The motor drive as set forth in claim 11, further comprising an enclosure holding the one or more power electronic switches directly upon the electric motor.

13. A method for operating a motor drive to provide AC power to an electric motor comprising:
energizing a DC bus with a DC voltage between a DC negative conductor and a DC positive conductor;
commanding for one or more power electronic switches to provide electrical continuity between one of the DC negative conductor or the DC positive conductor and an output terminal;
switching the one or more power electronic switches at a high switching speed to approximate an AC waveform on the output terminal; and
wherein each of the one or more power electronic switches are Gallium Nitride (GaN) power switches.

14. The method for operating a motor drive as set forth in claim 13, further including synchronizing timing between the controller and the power switch by a signal conditioner disposed between the controller and the power switch.

15. The method for operating a motor drive as set forth in claim 13, wherein the one or more power electronic switches includes a positive switch and a negative switch, with the positive switch responsive to an on command to be in a conductive state allowing electrical current to pass between the DC positive conductor and the output terminal, and with the negative switch responsive to an on command to be in a conductive state allowing electrical current to pass between the DC negative conductor and the output terminal;
periodically applying and removing the on command from each of the positive switch and the negative switch; and
inhibiting both of the positive switch and the negative switch from being in the conductive state simultaneously.

16. The method for operating a motor drive as set forth in claim 15, further including delaying applying the on command to one of the positive switch or the negative switch for a dead time after the on command is removed from other one of the positive switch or the negative switch.

17. The method for operating a motor drive as set forth in claim 15, wherein each of the power electronic switches has a turn-off time as a length of time between the on command being removed therefrom until the power electronic switch is in the non-conductive state; and
wherein each of the turn-on time and the turn-off time of each of the power electronic switches is substantially shorter than the dead time.

18. The method for operating a motor drive as set forth in claim 17, wherein the dead time plus the turn-on time minus the turn-off time is less than 300 ns with a switching frequency of between 30 kHz and 50 kHz.

19. The method for operating a motor drive as set forth in claim 17, wherein the motor drive produces a fifth-order harmonic distortion current upon the AC power supplied from the output terminal, with the fifth-order harmonic distortion current being proportional to an average distorted voltage;
wherein the average distorted voltage is proportional to an absolute value of the dead time plus the turn-on time minus the turn-off time; and
wherein the dead time is selected to minimize the fifth-order harmonic distortion current.

20. The method for operating a motor drive as set forth in claim 19, wherein the fifth-order harmonic distortion current is less than 1% of a fundamental component current of the AC power.
